(19) United States
(12) Patent Application Publication
(10) Pub. No.: US 2025/0256961 A1
(43) Pub. Date: Aug. 14, 2025

(54) METHOD FOR ALKALI-METAL SULFIDE PRODUCTION

(71) Applicant: Ampcera Inc., Milpitas, CA (US)

(72) Inventors: Hui Du, Tucson, AZ (US); James Emery Brown, Tucson, AZ (US)

(21) Appl. No.: 18/439,016

(22) Filed: Feb. 12, 2024

(51) Int. Cl. C01B 17/22

(52) U.S. Cl. CPC C01B 17/22; C01P 2002/72; C01P 2004/03; C01P 2004/51; C01P 2004/61

(57) ABSTRACT

A method for manufacturing alkali-metal sulfide with the chemical formula M₂S where M is at least one alkali metal, the method comprising: generating a vapor of an alkali metal; generating a vapor of elemental sulfur; bringing the generated alkali metal vapor into contact with the generated elemental sulfur vapor; and initiating a reaction between the alkali metal vapor and the elemental sulfur vapor to produce the alkali-metal sulfide.

### FIELD

The present application relates to the field of alkali-metal sulfide materials and the production thereof.

### BACKGROUND

Alkali-metal sulfide production often requires the use of hydrogen sulfide gas. This methodology typically involves the passage of hydrogen sulfide gas through a system containing alkali-carbonate powders, such as lithium carbonate (Li₂CO₃) or sodium carbonate (Na₂CO₃). Upon subjecting these mixtures to elevated temperatures, a decomposition reaction ensues, yielding alkali-metal sulfides (e.g., Li₂S or Na₂S) alongside carbon dioxide and water as by-products. Although effective, this approach is challenged by the corrosive nature of hydrogen sulfide gas, necessitating extensive safety measures during its transport and utilization, particularly on a large scale. Such requirements significantly elevate the operational costs and impose environmental and safety concerns associated with the manufacturing of alkali-metal sulfides.

The aforementioned challenges highlight a pressing need for alternative production methods that circumvent the use of hazardous materials while ensuring efficiency, safety, and environmental compatibility. This context sets the stage for ongoing research and development efforts aimed at innovating in the domain of alkali-metal sulfide manufacturing. The objective remains to identify and refine methodologies that address the drawbacks of traditional processes but also cater to the evolving demands of relevant industries, encompassing aspects beyond environmental and safety enhancements to include economic viability, process efficiency, and material properties optimization.

### SUMMARY

An aspect of the present description pertains to a method for manufacturing alkali-metal sulfide with the chemical formula M₂S where M is at least one alkali metal. The method comprises: generating a vapor of an alkali metal; generating a vapor of elemental sulfur; bringing the generated alkali metal vapor into contact with the generated elemental sulfur vapor; and initiating a reaction between the alkali metal vapor and the elemental sulfur vapor to produce the alkali-metal sulfide.

In a further aspect, the method further comprises conducting the reaction in a vacuum-compatible processing chamber equipped with at least one effusion cell for generating the alkali metal and at least one thermal cracker cell for generating elemental sulfur.

In a further aspect, the effusion cell is operated at a temperature in the range of 200° C. to 1500° C.

In a further aspect, the thermal cracker cell is operated at a temperature in the range of 100° C. to 900° C.

In a further aspect, the generated alkali metal vapor has a gaseous flux that is 1.5 to 2.5 times higher than the flux of the generated elemental sulfur vapor.

In a further aspect, the method further comprises a substrate within the processing chamber for collecting the synthesized alkali-metal sulfide.

In a further aspect, the substrate is a rotating conveyor belt.

In a further aspect, the method further includes a temperature-control block positioned adjacent to the rotating conveyor belt to regulate the temperature during the reaction.

In a further aspect, the temperature-control block serves as a heat block with a temperature range of 0° C. to 2000° C.

In a further aspect, the temperature-control block functions as a cold block with a temperature range capable of quenching the reaction, from −270° C. to 500° C.

In a further aspect, the method further comprises ionizing the generated alkali metal and elemental sulfur vapors in an electric field to initiate the reaction, wherein the electric field is generated by at least one plasma-generating system comprising at least one cathode and one anode connected to an external power source.

In a further aspect, a voltage applied across the cathode and anode creates an electric field strength in the range of 0 to 100,000 kilovolts per meter (kV/m).

In a further aspect, the produced alkali-metal sulfide is collected and removed from the reaction site using a collection mechanism.

In a further aspect, the processing chamber comprises a multi-vacuum level system including at least one of a dry roughing pump, an oil-based roughing pump, and a turbo pump.

In a further aspect, the processing chamber is backfilled with an inert gas to a predetermined pressure after the reaction.

In a further aspect, the rotating conveyor belt is controlled to maintain a predetermined rotation speed.

In a further aspect, the substrate's temperature is regulated by direct physical contact with a temperature-control block.

In a further aspect, the method further comprises removing the alkali-metal sulfide from the substrate using a mechanical device.

In a further aspect, the mechanical device is a knife or blade positioned to scrape the alkali-metal sulfide from the substrate.

In a further aspect, the method further comprises a step of purging the processing chamber with an inert gas before initiating the reaction to remove contaminants.

In a further aspect, the method further comprises loading the alkali metal and elemental sulfur into their respective cells in an inert atmosphere or a dry room before the vapor generation step.

In a further aspect, the alkali metal is loaded into the effusion cell and the elemental sulfur is loaded into the thermal cracker cell in forms selected from powder, granules, or chips to optimize vapor generation rates.

In a further aspect, the method further comprises a step of post-processing the synthesized alkali-metal sulfide by thermal annealing.

In another aspect, an alkali-metal sulfide powder with the chemical formula M₂S, where M is at least one alkali metal, characterized by: a median particle size (D50) of 0.01 μm to 10,000 μm; a D10 value at least 5% of the D50 value; and a D90 value no more than 300% of the D50 value.

In a further aspect, the powder has a morphology wherein over 50 wt % of the particles exhibit a sphericity index greater than 0.7.

In a further aspect, the powder has a purity of at least 99.5% by weight.

In another aspect, there is a method for manufacturing alkali-metal chalcogenide with the chemical formula M₂X where M is at least one alkali metal and X is at least one chalcogenide, the method comprising: generating a vapor of an alkali metal; generating a vapor of a chalcogenide; bringing the generated alkali metal vapor into contact with the generated chalcogenide vapor; and initiating a reaction between the alkali metal vapor and the chalcogenide vapor to produce the alkali-metal chalcogenide.

In another aspect, there is a method for manufacturing a metal chalcogenide with the chemical formula M₂X where M is at least one metal having a boiling point below 1500° C. and X is at least one chalcogenide, the method comprising: generating a vapor of a metal having a boiling point below 1500° C.; generating a vapor of a chalcogenide; bringing the generated metal vapor into contact with the generated chalcogenide vapor; and initiating a reaction between the metal vapor and the chalcogenide vapor to produce the metal chalcogenide.

In another aspect, there is a method for manufacturing a metal oxide with the chemical formula M₂O where M is at least one metal having a boiling point below 1500° C., the method comprising: generating a vapor of a metal having a boiling point below 1500° C.; providing an oxygen gas; bringing the generated metal vapor into contact with the oxygen gas; and initiating a reaction between the metal vapor and the oxygen gas to produce the metal oxide.

Other embodiments of the disclosed system will become apparent from the following detailed description, the accompanying drawings, and the appended claims.

### BRIEF DESCRIPTION OF THE DRAWINGS

FIG. 1A: A schematic illustration of a heat-assisted processing approach for the manufacturing of alkali-metal sulfide materials.

FIG. 1B: A schematic illustration of a heat-assisted processing approach for the manufacturing of alkali-metal sulfide materials.

FIG. 1C: A schematic illustration of a heat-assisted processing approach for the manufacturing of alkali-metal sulfide materials.

FIG. 1D: A schematic illustration of a heat-assisted processing approach for the manufacturing of alkali-metal sulfide materials.

FIG. 1E: A flowchart of the heat-assisted processing approach for the manufacturing of alkali-metal sulfide materials.

FIG. 2A: A schematic illustration of a plasma-assisted processing approach for the manufacturing of alkali-metal sulfide materials.

FIG. 2B: A schematic illustration of a plasma-assisted processing approach for the manufacturing of alkali-metal sulfide materials.

FIG. 2C: A schematic illustration of a plasma-assisted processing approach for the manufacturing of alkali-metal sulfide materials.

FIG. 2D: A schematic illustration of a plasma-assisted processing approach for the manufacturing of alkali-metal sulfide materials.

FIG. 2E: A flowchart of the plasma-assisted processing approach for the manufacturing of alkali-metal sulfide materials.

FIG. 3A: A schematic illustration of an effusion cell used in the evaporation of the alkali-metal.

FIG. 3B: A digital image of a representative effusion cell used in the evaporation of alkali-metal.

FIG. 3C: A schematic illustration of a thermal cracker cell used in the evaporation of elemental sulfur.

FIG. 3D: A digital image of a thermal cracker cell used in the evaporation of elemental sulfur.

FIG. 4A: A schematic illustration of a rotating conveyor belt used in the manufacturing of alkali-metal sulfide materials.

FIG. 4B: A schematic illustration of a rotating conveyor belt used in the manufacturing of alkali-metal sulfide materials.

FIG. 5A: A representative x-ray diffraction pattern of an alkali-metal sulfide processed using a heat-assisted processing approach . . .

FIG. 5B: Representative scanning electron microscopy images of an alkali-metal sulfide powder manufactured using a heat-assisted processing approach.

FIG. 5C: A representative particle size distribution of an alkali-metal sulfide powder manufactured using a heat-assisted processing approach.

FIG. 6A: A representative x-ray diffraction pattern of an alkali-metal sulfide processed using a plasma-assisted processing approach . . .

FIG. 6B: Representative scanning electron microscopy images of an alkali-metal sulfide powder manufactured using a plasma-assisted processing approach.

FIG. 6C: A representative particle size distribution of an alkali-metal sulfide powder manufactured using a plasma-assisted processing approach.

### DETAILED DESCRIPTION

The present description relates to a method for manufacturing alkali-metal sulfide, specifically with the chemical formula M₂S, where ‘M’ represents one or more alkali metals, such as lithium, sodium, and potassium. The description encompasses techniques for generating the necessary reactant vapors and their subsequent reaction to produce alkali-metal sulfide as novel alkali-metal sulfide powder having a defined medium particle size and narrow particle size distribution.

Alkali-metal sulfides, particularly those with the chemical formula M₂S, encompass a group of compounds depending on the specific alkali metal ‘M’. Lithium sulfide (Li₂S) is one such compound, useful its high electrochemical stability and potential use in battery technologies, especially in lithium-sulfur batteries. Sodium sulfide (Na₂S) is another variant, useful for its applications in sodium-based battery systems and its importance in various industrial processes. Potassium sulfide (K₂S) is also significant, with its properties lending it to diverse applications in both energy storage systems and chemical synthesis. Other alkali-metal sulfide materials include, for example, cesium sulfide (Cs₂S), rubidium sulfide (Rb₂S), and francium sulfide (Fr₂S). A mixed alkali metal sulfide is a compound that contains two or more alkali metals and sulfur. Each of these sulfides shares a common chemical structure but exhibits distinct physical and chemical properties depending on the alkali metal involved.

Generation of Alkali Metal Vapor: The method for producing alkali-metal sulfides involves generating a vapor of at least one alkali metal. This can be achieved through several techniques. One method is using an effusion cell where an alkali metal source is vaporized through heating, which could include evaporation or sublimation. The following detailed description focuses primarily on the generation of alkali metal vapor using the effusion cell, but the present description is not limited by this technique. Alternative methods may include thermal decomposition of alkali metal compounds, which can release alkali metal vapors without the need for a physical effusion cell. Electron beam evaporation is another technique, where an electron beam may be used to vaporize the alkali metal. Additionally, sputtering can eject alkali metals from a target material using high-energy ions. Laser ablation utilizes focused laser pulses to vaporize alkali metal from a solid target. Gas-phase reactions may also generate alkali metals in vapor form, potentially bypassing the need for direct physical evaporation. Furthermore, electrical methods can release alkali metal vapors through electrical heating. Other potential methods include utilizing alkali metal reservoirs other than pure alkali metal, such as alloys or other alkali-metal-containing materials, to generate vapors.

Generation of Elemental Sulfur Vapor: The method for producing alkali-metal sulfides involves generating a vapor of an elemental sulfur. This can be achieved through several techniques. The generation of elemental sulfur vapor can be performed using a thermal cracker cell, where sulfur is heated to produce vapor, which can include evaporation or sublimation. The following detailed description focuses primarily on the generation of elemental sulfur vapor using the thermal cracker cell, but the present description is not limited by this technique. Alternative heating methods not reliant on a thermal cracker cell, such as furnaces or ovens, can also be employed. Chemical generation of sulfur vapor through chemical reactions is another possibility. Electrical methods, as well as other heating techniques like lasers, microwaves, or plasma, can induce sulfur vaporization. Each of these methods provides a different approach to generating sulfur vapor, which can then react with the alkali metal vapor to form alkali-metal sulfide.

Reaction to Produce Alkali-Metal Sulfide: The synthesis of alkali-metal sulfide is centered around the step of initiating a reaction between the alkali metal vapor and the elemental sulfur vapor. The reaction can be facilitated through heat-assisted techniques and through plasma-assisted techniques. The following detailed description focuses primarily on the initiation of the reaction using heat or plasma. However, the present description is not limited by this technique. Alternatively, electromagnetic fields, including those generated by microwaves or radio frequencies, can stimulate the reaction. Additionally, innovative methods such as photochemical reactions using light, ultrasonic techniques employing sound waves, or the introduction of reactive gases or chemicals may also be possible viable pathways for initiating alkali-metal sulfide formation.

The present description also relates to an alkali-metal sulfide powder that can be produced by the methods described herein. The alkali-metal sulfide powder, with the chemical formula M₂S, where M is at least one of lithium, sodium, and potassium, is characterized by: a median particle size (D50) of 0.01 μm to 10,000 μm; a D10 value at least 5% of the D50 value; and a D90 value no more than 300% of the D50 value. In an aspect, the alkali-metal sulfide powder may have a morphology wherein over 50 wt % of the particles exhibit a sphericity index greater than 0.7, preferably greater than 0.8. In another aspect, the alkali-metal sulfide powder may have a purity of at least 99.5% by weight.

The following description relates a method for manufacturing alkali-metal sulfide materials.

In an embodiment, a method for manufacturing alkali-metal sulfides may be a low-vacuum heat-assisted approach.

In an aspect of the embodiment, a low-vacuum heat-assisted approach may comprise a vacuum-compatible processing chamber further comprising at least one effusion cell for the evaporation of alkali-metal, at least one thermal cracker cell for the evaporation of elemental sulfur, at least one rotating conveyor belt system comprising a single rotating conveyor belt serving as a substrate for elemental sulfur and alkali-metal to deposit on forming a material layer, a temperature-controlled block between the rotating conveyor belt to drive the reaction between elemental sulfur and alkali-metal on the rotating conveyor belt, and a knife or blade to remove the alkali-metal sulfide from the rotating conveyor belt, and at least one collection crucible to collect the formed alkali-metal sulfide.

In another aspect of the embodiment, a low-vacuum heat-assisted approach for manufacturing alkali-metal sulfides may comprise evaporating both the alkali-metal and elemental sulfur to form a gaseous elemental mixture in the processing chamber, wherein the gaseous elemental mixture forms a layer of elemental sulfur and alkali-metal on the surface of the rotating conveyor belt, wherein the rotating conveyor belt is heated to drive the reaction between the elemental sulfur and alkali-metal to form a layer of alkali-metal sulfide with the stoichiometric formulation M₂S (where M is Li, Na, or K), wherein the layer of alkali-metal sulfide is removed using a knife in physical contact with the rotating conveyor belt and collected in a collection crucible at the bottom of the processing chamber.

In another embodiment, a method for manufacturing alkali-metal sulfides is a high-vacuum plasma-assisted approach.

In an aspect of the embodiment, a high-vacuum plasma-assisted approach comprises a vacuum-compatible processing chamber further comprising at least one effusion cell for the evaporation of alkali-metal, at least one thermal cracker cell for the evaporation of elemental sulfur, at least one plasma generation system, at least one rotating conveyor belt system comprising a single rotating conveyor belt serving as a substrate of alkali-metal sulfide to deposit on forming a materials layer, a temperature-controlled block between the rotating conveyor belt to either drive the reaction between residual elemental sulfur and alkali-metal on the rotating conveyor belt or quench the alkali-metal sulfide, and a knife or blade to remove the alkali-metal sulfide from the rotating conveyor belt, and at least one collection crucible to collect the formed alkali-metal sulfide

In another aspect of the embodiment, a plasma-assisted approach for manufacturing alkali-metal sulfides comprises evaporating both the alkali-metal and elemental sulfur to form a gaseous elemental mixture in the processing chamber, wherein the gaseous elemental mixture is passed through an electric field, generated by the plasma generation system comprising at least one cathode and one anode connected to an external power source, forming a plasma plume, wherein the reaction between elemental sulfur and alkali-metal occurs forming alkali-metal sulfide with the stoichiometric formulation M₂S (M is Li, Na, or K), wherein the formed alkali-metal sulfide deposits onto a rotating conveyor belt and removed with a blade or knife and collected in the collection crucible at the bottom of the processing chamber.

In yet another aspect of the embodiment, a temperature control block may be positioned between the rotating conveyor belt, a temperature control block that 1) can be used to provide heat to drive the reaction between residual elemental sulfur and alkali-metal to form alkali-metal sulfide, or 2) is a cold block used to quench or rapidly cool the deposited alkali-metal sulfide to enhance crystal structure and further reduce particle size.

The method for manufacturing alkali-metal sulfide materials is further described below.

In an embodiment, a method for manufacturing alkali-metal sulfide may be a low-vacuum heat-assisted approach comprising a vacuum-compatible processing chamber.

In an aspect of the embodiment, a vacuum-compatible processing chamber may comprise at least one effusion cell for the evaporation of an alkali metal.

In another aspect of the embodiment, a vacuum-compatible processing chamber may comprise at least one thermal cracker cell for the evaporation of elemental sulfur.

In yet another aspect of the embodiment, a vacuum-compatible processing chamber may comprise one or more rotating conveyor belt systems, comprising a single rotating conveyor belt serving as a substrate, wherein elemental sulfur and alkali metal deposit onto the surface forming a material layer. The rotation of the conveyor belt may be automated and controlled externally of the vacuum-compatible processing chamber.

In yet another aspect of the embodiment, a vacuum-compatible processing chamber may comprise a heat block positioned between the single rotating conveyor belt, wherein the heat drives the reaction between the elemental sulfur and alkali-metal to form alkali-metal sulfides.

In yet another aspect of the embodiment, a vacuum-compatible processing chamber may comprise a knife or blade to remove the alkali-metal sulfide layer from the rotating conveyor belt, wherein at least one collection crucible may be located at the bottom of the vacuum-compatible processing chamber to collect the alkali-metal sulfide.

In another embodiment, a method for manufacturing alkali-metal sulfide may be a high-vacuum plasma-assisted approach comprising a vacuum-compatible processing chamber.

In an aspect of the embodiment, a vacuum-compatible processing chamber may comprise at least one effusion cell for the evaporation of an alkali metal.

In another aspect of the embodiment, a vacuum-compatible processing chamber may comprise at least one thermal cracker cell for the evaporation of elemental sulfur.

In yet another aspect of the embodiment, a vacuum-compatible processing chamber may comprise at least one plasma generation system, comprising at least one cathode and one anode connected to an external power source, to generate an electric to ionize the evaporated alkali metal and elemental sulfur forming a plasma plume resulting in the formation of alkali-metal sulfide.

In yet another aspect of the embodiment, a vacuum-compatible processing chamber may comprise at least one rotating conveyor belt system, comprising a single rotating conveyor belt serving as a substrate, wherein the alkali-metal sulfide may deposit onto the surface forming a material layer. The rotation of the conveyor belt may be automated and controlled externally of the vacuum-compatible processing chamber.

In yet another aspect of the embodiment, a vacuum-compatible processing chamber may comprise a heat block positioned between the conveyor belt, wherein the heat drives the reaction between any residual elemental sulfur and alkali-metal to form alkali-metal sulfides to enhance the yield rate. Alternatively, or in combination thereof, a vacuum-compatible processing chamber may comprise a cold block positioned between the conveyor belt to rapidly cool or quench the alkali-metal sulfides to enhance crystal structure and further reduce particle size.

In yet another aspect of the embodiment, a vacuum-compatible processing chamber may comprise a knife or blade to remove the alkali-metal sulfide layer from the rotating conveyor belt, wherein at least one collection crucible may be located at the bottom of the vacuum-compatible processing chamber to collect the alkali-metal sulfide.

In yet another embodiment, a method for manufacturing alkali-metal sulfide may include heating the at least one effusion cell to a temperature in the range of 200≤T≤1500° C. to evaporate the alkali metal.

In yet another embodiment, a method for manufacturing alkali-metal sulfide may include heating the at least one thermal cracker cell to a temperature in the range of 100≤T≤900° C. to evaporate the elemental sulfur.

In yet another embodiment, a method for manufacturing alkali-metal sulfide may comprise of a vacuum-compatible processing chamber with a latched door on top, wherein upon completion of the manufacturing process the collection crucible may be removed to collect the alkali-metal sulfides.

The present disclosure relates to a heat-assisted processing approach for manufacturing alkali-metal sulfide materials.

A heat-assisted processing approach for the manufacturing of alkali-metal sulfide materials may be a low-vacuum processing approach.

A heat-assisted processing approach for the manufacturing of alkali-metal sulfide materials may include a vacuum-compatible processing chamber comprising at least one effusion cell, at least one thermal cracker cell, at least one rotating conveyor belt, at least one temperature-controlled block between the rotating conveyor belt, and at least one collection crucible.

The vacuum-compatible processing chamber and all other components associated with the manufacturing of alkali-metal sulfide materials using a heat-assisted processing approach may be located in a dry room or an inert environment such as a glovebox.

A heat-assisted processing approach for the manufacturing of alkali-metal sulfide materials may include the following steps. It should be noted that the steps are guidelines for manufacturing alkali-metal sulfide materials and are not met to limit the scope of the manufacturing process. The manufacturing process may include additional steps are sub-steps that are not listed but would be apparent to those skilled in the art.

The present description relates to the preparation steps for the heat-assisted processing approach for manufacturing alkali-metal sulfide materials.

The at least one effusion cell may be loaded into the vacuum-compatible processing chamber, wherein the vacuum-compatible processing chamber comprises at least one port with a mounting flange designed to match a mounting flange on the at least one effusion cell to secure it under vacuum conditions. Vacuum grease may be applied to the mounting flanges to provide lubrication and further seal the port.

Alternatively, the at least one effusion cell may already be loaded into the vacuum-compatible processing, wherein the loading step can be omitted.

The at least one effusion cell may comprise a crucible to contain the alkali-metal material. The alkali metal may be in the form of powder, granules, or chips. The alkali metal may be packed into the crucible, preferably in an inert environment such as a glovebox. Alternatively, the alkali metal may be packed into the crucible in a dry room with a moisture content below 1000 ppm.

The crucible containing the packed alkali-metal material may be loaded into the effusion cell.

The at least one thermal cracker cell may be loaded into the vacuum-compatible processing chamber, wherein the vacuum-compatible processing chamber comprises at least one port with a mounting flange designed to match a mounting flange on the at least one thermal cracker cell to secure it under the vacuum conditions. Vacuum grease may be applied to the mounting flanges to provide lubrication and further seal the port.

Alternatively, the at least one thermal cracker cell may already be loaded into the vacuum-compatible processing, wherein the loading step can be omitted.

The at least one thermal cracker cell may comprise a crucible to contain elemental sulfur. The elemental sulfur may be packed into the crucible, preferably in an inert environment such as a glovebox. Alternatively, the elemental sulfur may be packed into the crucible in a dry room with a moisture content below 1000 ppm.

The crucible containing the packed elemental sulfur may be loaded into the thermal cracker cell.

The present description relates to the conditioning steps for the heat-assisted processing approach for manufacturing alkali-metal sulfide materials.

The vacuum-compatible processing chamber may be evacuated to purge moisture, atmosphere, and other potential contaminants. The processing chamber may reach a vacuum level in the range of 10²≤p≤10⁻¹⁰ torr, with a preferred low vacuum range of 10¹≤p≤10⁻⁶ torr.

During purging, the effusion and thermal cracker cells may be heated to a conditioning temperature in the range of 50≤T≤200° C. to remove any residual moisture within the alkali metal or elemental sulfur. It should also be noted that during purging, any shutters on the effusion or thermal cracker cells should preferably be in the open position.

Purge duration may be in the range of 1≤t<500,000 seconds, with a preferred range of 30≤t≤50,000 seconds.

The processing chamber may comprise of a multi-vacuum level system including, for example, a dry roughing pump, an oil-based roughing pump, or a turbo pump.

Following the purge, the vacuum-compatible processing chamber may be backfilled with an inert gas such, for example, helium, nitrogen, or argon to a pressure in the range of 760≤p≤10⁻¹ torr. Inert gas purity may be in the range of 97≤p≤99.99999%.

The steps of purging followed by backfilling with inert gas may be repeated several times to reach the desired purity and vacuum levels within the processing chamber.

After the final purging step, the processing chamber may have a vacuum level in the range of 10²≤p≤10⁻¹⁰ torr, with a preferred range of 10¹≤p≤10⁻⁶ torr.

In addition to the vacuum level, purity may be monitored with moisture and oxygen sensors located in the processing chamber, especially if processing at a rough or low vacuum level in the range of 10²≤p≤10⁻¹ torr. Moisture and oxygen concentrations may be in the range of 1000≤p≤10⁻⁶ ppm.

The present description relates to the processing steps of the heat-assisted processing approach for manufacturing alkali-metal sulfide materials.

The at least one effusion cell, comprising the alkali metal, may be heated to a temperature in the range of 500≤T≤1500° C. to evaporate said alkali metal.

The at least one thermal cracker cell, comprising elemental sulfur, may be heated to a temperature in the range of 100≤T≤900° C. to evaporate said elemental sulfur.

The evaporated alkali metal preferably has a flux twice as high as the elemental sulfur to achieve the stoichiometric relationship of 2:1 (i.e., M₂S with M being Li, Na, K, etc.).

The flux may be controlled by adjusting the set temperature point of the at least one effusion cell thereby controlling the evaporation rate of gaseous alkali metal. The set temperature point may be controlled by controlling the amperage delivered to the effusion cell or the temperature of the chilled water circulating within the effusion cell (if applicable).

Alternatively, or in combination thereof, the flux may be controlled by adjusting the temperature of the at least one thermal cracker cell, particularly the cracker head, thereby controlling the evaporation rate of gaseous elemental sulfur. The set temperature point may be controlled by controlling the amperage delivered to the cell or the temperature of the chilled water circulating within the effusion cell (if applicable).

The flux may be controlled by varying the temperature of the at least one effusion cell within a set range thereby controlling, but allowing for variation, the evaporation rate of gaseous alkali metal. The temperature range can be controlled within the set range by controlling the amperage delivered to the effusion cell or the temperature of the chilled water circulating within the effusion cell (if applicable).

Alternatively, or in combination thereof, the flux may be controlled by varying the temperature of the at least one thermal cracker cell within a set range thereby controlling, but allowing for variation, the evaporation rate of gaseous elemental sulfur. The temperature range can be controlled within the set range by controlling the amperage delivered to the thermal cracker cell or the temperature of the chilled water circulating within the thermal cracker cell (if applicable).

In yet another alternative, or combination with any of the aforementioned temperature control strategies, the flux may be controlled by opening and closing the shutter on top of the at least one effusion cell or the at least one thermal cracker cell at set durations or intervals.

The evaporated alkali-metal and elemental sulfur gases may mix inside the processing chamber and form a mixed or alloy material layer on the surface of the rotating conveyor belt.

The deposited material layer may have a stoichiometric alkali-metal to elemental sulfur relationship of at least 1.5:1, more preferably 1.6:1, more preferably 1.7:1, more preferably 1.8:1, more preferably 1.9:1, more preferably 2:1.

The deposited material layer may have a stoichiometric alkali-metal to elemental sulfur relationship of no more than 2.5:1, more preferably 2.4:1, more preferably 2.3:1, more preferably 2.2:1, more preferably 2.1:1, more preferably 2:1.

The rotating conveyor belt may rotate at a rate in the range of 0.01≤t≤1000 mm per second, with a preferred range of 0.1≤t≤10 mm per second.

The temperature of the rotating conveyor belt may be controlled using a temperature-controlled block such as a heat block positioned in the headspace above the side of the belt facing the at least one effusion and at least one thermal cracker cell, or more accurately described as in between the rotating conveyor belt.

The heat block may provide a temperature in the range of 0≤T≤2000° C., with a preferred range of 100≤T≤1000° C.

The heat block may provide a sufficient amount of heat to drive the reaction between the alkali-metal and elemental sulfur in the deposited material layer forming alkali-metal sulfide.

A knife or blade may be used to scrape the alkali-metal sulfide off and into the at least one collection crucible at the bottom of the processing chamber.

The present description relates to the post-processing and collection steps of the heat-assisted processing approach for manufacturing alkali-metal sulfide materials.

The heat-assisted processing approach may be considered complete when 1) the alkali-metal is depleted in the at least one effusion cell, 2) the elemental sulfur is depleted in the at least one thermal cracker cell, or 3) the desired amount of alkali-metal sulfide has been collected in the at least one collection crucible.

The at least one effusion cell may be turned off, allowing it to cool, with the shutter orientated in the closed position. Chilled water or antifreeze may run through coolant lines in the effusion cell enabling a more rapid cooling.

The at least one thermal cracker cell may be turned off, allowing it to cool, with the shutter orientated in the closed position. Chilled water or antifreeze may run through coolant lines in the thermal cracker cell enabling a more rapid cooling.

The heat block located between the conveyor belt may be turned off allowing it to cool. The heat block may also comprise of chilled water or antifreeze lines enabling a more rapid cooling.

The processing chamber may be backfilled with an inert gas to a pressure of 760 torr. An inert gas may include, for example, helium, nitrogen, or argon.

A latched door on top of the processing chamber may be unlatched and opened to remove the at least one collection crucible comprising alkali-metal sulfide.

The alkali-metal sulfide may be further processed to convert any residual elemental sulfur and alkali metal into alkali-metal sulfide. Further processing may include thermal annealing at a temperature in the range of 100≤T≤1000° C.

The at least one effusion cell may be removed from the processing chamber for cleaning. Alternatively, the at least one effusion cell crucible may be removed, cleaned, and repacked with alkali metal for additional heat-assisted processing.

The at least one thermal cracker cell may be removed from the processing chamber for cleaning. Alternatively, the at least one thermal cracker cell crucible may be removed, cleaned, and repacked with elemental sulfur for additional heat-assisted processing.

The present disclosure relates to a plasma-assisted processing approach for manufacturing alkali-metal sulfide materials.

A plasma-assisted processing approach for the manufacturing of alkali-metal sulfide materials may be a high-vacuum processing approach.

A plasma-assisted processing approach for the manufacturing of alkali-metal sulfide materials may include a vacuum-compatible processing chamber comprising at least one effusion cell, at least one thermal cracker cell, at least one plasma generation system comprising at least one cathode and one anode connected to an external circuit, at least one rotating conveyor belt, at least one temperature-controlled block between the rotating conveyor belt, and at least one collection crucible.

The vacuum-compatible processing chamber and all other components associated with the manufacturing of alkali-metal sulfide materials using a plasma-assisted processing approach may be located in a dry room or an inert environment such as a glovebox.

A plasma-assisted processing approach for the manufacturing of alkali-metal sulfide materials may include the following steps. It should be noted that the steps are guidelines for manufacturing alkali-metal sulfide materials and are not met to limit the scope of the manufacturing process. The manufacturing process may include additional steps are sub-steps that are not listed but would be apparent to those skilled in the art.

The present description relates to the preparation steps for the plasma-assisted processing approach for manufacturing alkali-metal sulfide materials.

The at least one effusion cell may be loaded into the vacuum-compatible processing chamber, wherein the vacuum-compatible processing chamber comprises at least one port with a mounting flange designed to match a mounting flange on the at least one effusion cell to secure it under vacuum conditions. Vacuum grease may be applied to the mounting flanges to provide lubrication and further seal the port.

Alternatively, the at least one effusion cell may already be loaded into the vacuum-compatible processing, wherein the loading step can be omitted.

The at least one effusion cell may comprise a crucible to contain the alkali-metal material. The alkali metal may be in the form of powder, granules, or chips. The alkali metal may be packed into the crucible, preferably in an inert environment such as a glovebox. Alternatively, the alkali metal may be packed into the crucible in a dry room with a moisture content below 1000 ppm.

The crucible containing the packed alkali-metal material may be loaded into the at least one effusion cell.

The at least one thermal cracker cell may be loaded into the vacuum-compatible processing chamber, wherein the vacuum-compatible processing chamber comprises at least one port with a mounting flange designed to match a mounting flange on the at least one thermal cracker cell to secure it under the vacuum conditions. Vacuum grease may be applied to the mounting flanges to provide lubrication and further seal the port.

Alternatively, the at least one thermal cracker cell may already be loaded into the vacuum-compatible processing, wherein the loading step can be omitted.

The at least one thermal cracker cell may comprise a crucible to contain elemental sulfur. The elemental sulfur may be packed into the crucible, preferably in an inert environment such as a glovebox. Alternatively, the elemental sulfur may be packed into the crucible in a dry room with a moisture content below 1000 ppm.

The crucible containing the packed elemental sulfur may be loaded into the thermal cracker cell.

The present description relates to the conditioning steps of the plasma-assisted processing approach for manufacturing alkali-metal sulfide materials.

The vacuum-compatible processing chamber may be evacuated to purge moisture, atmosphere, and other potential contaminants. The processing chamber may reach a vacuum level in the range of 10²≤p≤10⁻¹¹ torr, with a preferred range of 10⁰≤p≤10⁻⁷ torr.

During purging, the effusion and thermal cracker cells may be heated to a conditioning temperature in the range of 50≤T≤200° C. to remove any residual moisture within the alkali metal or elemental sulfur. It should also be noted that during purging, any shutters on the effusion or thermal cracker cells should preferably be in the open position.

Purge duration may be in the range of 1≤t≤500,000 seconds, with a preferred range of 30≤t≤50,000 seconds.

The processing chamber may comprise a multi-vacuum level system including, for example, a dry roughing pump, an oil-based roughing pump, and a turbo pump. For plasma-assisted processing, the processing chamber may further comprise one or more ion-getter pumps.

Following the purge, the vacuum-compatible processing chamber may be backfilled with an inert gas such, for example, helium, nitrogen, or argon to a pressure in the range of 760≤p≤10⁻¹ torr. Inert gas purity may be in the range of 97≤p≤99.99999%.

The steps of purging followed by backfilling with inert gas may be repeated several times to reach the desired vacuum levels within the processing chamber.

After the final purging step, the processing chamber may have a vacuum level in the range of 102≤p≤10⁻¹¹ torr, with a preferred range of 10⁰≤p≤10⁻⁷ torr.

The present description relates to the processing steps of the plasma-assisted processing approach for manufacturing alkali-metal sulfide materials.

The at least one effusion cell, comprising the alkali metal, may be heated to a temperature in the range of 200≤T≤1500° C. to evaporate said alkali metal.

The at least one thermal cracker cell, comprising elemental sulfur, may be heated to a temperature in the range of 100≤T≤900° C. to evaporate said elemental sulfur.

A DC voltage may be applied across the at least one cathode and one anode to generate an electric field with a strength in the range of 0≤P≤100,000 kilovolts per meter (kV/m). Alternatively, an AC voltage may be applied in certain situations or applications where an alternating voltage field is desired.

The evaporated alkali-metal preferably has a flux twice as high as the elemental sulfur to achieve the stoichiometric relationship of 2:1 (i.e., M₂S with M being Li, Na, K, etc.).

The flux may have a stoichiometric alkali-metal to elemental sulfur relationship of at least 1.5:1, more preferably 1.6:1, more preferably 1.7:1, more preferably 1.8:1, more preferably 1.9:1, more preferably 2:1.

The flux may have a stoichiometric alkali-metal to elemental sulfur relationship of no more than 2.5:1, more preferably 2.4:1, more preferably 2.3:1, more preferably 2.2:1, more preferably 2.1:1, more preferably 2:1.

The flux may be controlled by adjusting the set temperature point of the at least one effusion cell thereby controlling the evaporation rate of gaseous alkali metal. The set temperature point may be controlled by controlling the amperage delivered to the effusion cell or the temperature of the chilled water circulating within the effusion cell (if applicable).

Alternatively, or in combination thereof, the flux may be controlled by adjusting the temperature of the at least one thermal cracker cell, particularly the cracker head, thereby controlling the evaporation rate of gaseous elemental sulfur. The set temperature point may be controlled by controlling the amperage delivered to the thermal cell or the temperature of the chilled water circulating within the effusion cell (if applicable).

The flux may be controlled by varying the temperature of the at least one effusion cell within a set range thereby controlling, but allowing for variation, the evaporation rate of gaseous alkali metal. The temperature range can be controlled within the set range by controlling the amperage delivered to the effusion cell or the temperature of the chilled water circulating within the effusion cell (if applicable).

Alternatively, or in combination thereof, the flux may be controlled by varying the temperature of the at least one thermal cracker cell within a set range thereby controlling, but allowing for variation, the evaporation rate of gaseous elemental sulfur. The temperature range can be controlled within the set range by controlling the amperage delivered to the thermal cracker cell or the temperature of the chilled water circulating within the thermal cracker cell (if applicable).

In yet another alternative, or combination with any of the aforementioned temperature control strategies, the flux may be controlled by opening and closing the shutter on top of the effusion cell or thermal cracker cell at set durations or intervals.

The gaseous alkali-metal and elemental sulfur may mix as they enter the generated electric field between the cathode and anode, wherein the gaseous mix may ionize resulting in the formation of a plasma plume.

In some instances, an inert gas may be introduced directly into the plasma plume to enhance ionization and alkali-metal sulfide formation. An inert gas may include, for example, argon, nitrogen, helium, neon, krypton, xenon, etc.

The alkali-metal sulfide may form inside the plasma plume and either deposit onto the at least one rotating conveyor belt above, fall to the at least one collection crucible below, or a combination of the two.

While the deposited alkali-metal sulfide layer is presumed to be entirely alkali-metal sulfide with the chemical formula M₂S (with M being Li, Na, or K), there may still be some residual alkali-metal and elemental sulfur in the deposited layer. The percentage of alkali-metal and elemental sulfur in the layer is less than 99%, more preferably less than 50%, more preferably less than 25%, more preferably less than 10%, more preferably less than 1%, more preferably less than 0.5%, more preferably less than 0.25%, more preferably less than 0.1%, more preferably less than 0.05%, more preferably less than 0.01%, more preferably less than 0.001%.

The temperature of the rotating conveyor belt may be controlled using a temperature-controlled block such as a heat block positioned in the headspace above the side of the belt facing the effusion and thermal cracker cells or more accurately described as in between the rotating conveyor belt.

The heat block may provide a temperature in the range of 0≤T≤2000° C., with a preferred range of 100≤T≤1000° C.

The heat block may provide a sufficient amount of heat to drive the reaction between the residual alkali-metal and elemental sulfur forming alkali-metal sulfide.

Alternatively, the temperature of the rotating conveyor belt may be controlled using a cold block positioned in the headspace above the side of the belt facing the effusion and thermal cracker cells or more accurately described as in between the rotating conveyor belt.

The cold block may provide a temperature in the range of −270≤T≤500° C., with a preferred range of −200≤T≤100° C.

The cold block may rapidly cool or quench the alkali-metal sulfides to enhance crystal structure and further reduce particle size. It is presumed that the cold block is used when the percentage of residual alkali-metal and elemental sulfur is negligible.

A knife or blade may be used to scrape the alkali-metal sulfide off the rotating conveyor belt and into the at least one collection crucible at the bottom of the processing chamber.

The particle size of the alkali-metal sulfide may be controlled in the plasma-assisted processing by 1) controlling the flux of the alkali-metal, 2) controlling the flux of the elemental sulfur, 3) adjusting the electric field strength between the cathode and anode, 4) enhancing quenching efficiency or rate of a cold block, or 5) a combination thereof.

The present description relates to the post-processing and collection steps of the plasma-assisted processing approach for manufacturing alkali-metal sulfide materials.

The plasma-assisted processing approach may be considered complete when 1) the alkali-metal is depleted in the at least one effusion cell, 2) the elemental sulfur is depleted in the at least one thermal cracker cell, or 3) the desired amount of alkali-metal sulfide has been collected in the at least one collection crucible.

The at least one effusion cell may be turned off, allowing it to cool, with the shutter orientated in the closed position. Chilled water or antifreeze may run through coolant lines in the effusion cell enabling a more rapid cooling.

The power source in the plasma generation system may be turned off, terminating the electric field between the at least one cathode and one anode.

The at least one thermal cracker cell may be turned off, allowing it to cool, with the shutter orientated in the closed position. Chilled water or antifreeze may run through coolant lines in the thermal cracker cell enabling a more rapid cooling.

The heat block located between the conveyor belt may be turned off allowing it to cool. The heat block may also comprise of chilled water or antifreeze lines enabling a more rapid cooling. Alternatively, the cold block located between the conveyor belt may be allowed to warm up.

The processing chamber may be backfilled with an inert gas to a pressure of 760 torr. An inert gas may include, for example, helium, nitrogen, or argon.

A latched door on top of the processing chamber may be unlatched and opened to remove the at least one collection crucible comprising alkali-metal sulfide.

The alkali-metal sulfide may be further processed to convert any residual elemental sulfur and alkali metal into alkali-metal sulfide. Further processing may include thermal annealing at a temperature in the range of 100≤T≤1000° C.

The at least one effusion cell may be removed from the processing chamber for cleaning. Alternatively, the crucible may be removed, cleaned, and repacked with alkali metal for additional plasma-assisted processing.

The at least one thermal cracker cell may be removed from the processing chamber for cleaning. Alternatively, the crucible may be removed, cleaned, and repacked with elemental sulfur for additional plasma-assisted processing.

The present disclosure relates to a processing chamber used for manufacturing alkali-metal sulfide materials.

A processing chamber for the heat-assisted manufacturing of alkali-metal sulfide materials comprises a vacuum-compatible chamber, at least one effusion cell, at least one thermal cracker cell, at least one rotating conveyor belt system comprising a single rotating conveyor belt, two or more pulley wheels, one or more temperature-control blocks, and one knife or blade, and at least one collection crucible.

A processing chamber for the plasma-assisted manufacturing of alkali-metal sulfide materials comprises a vacuum-compatible chamber, at least one effusion cell, at least one thermal cracker cell, at least one plasma generation system comprising at least one cathode, and one anode connected to an external power source, at least one rotating conveyor belt system comprising a single rotating conveyor belt, two or more pulley wheels, one or more temperature-control blocks, and one knife or blade, and at least one collection crucible.

The present description relates to the vacuum-compatible chamber used for manufacturing alkali-metal sulfide materials.

A processing chamber used in the heat-assisted processing approach for manufacturing alkali-metal sulfide materials may be vacuum-compatible and preferably comprised of stainless steel. Alternatively, a vacuum-compatible processing chamber may comprise any material that is thermally compatible with the at least one effusion cell, the at least one thermal cracker cell, and the at least one heat block used to control the temperature of the rotating conveyor belt, and is chemically compatible with the alkali-metal, elemental sulfide, and the formed alkali-metal sulfide material.

A processing chamber used in the plasma-assisted processing approach for manufacturing alkali-metal sulfide materials may be vacuum-compatible and preferably comprised of stainless steel. Alternatively, a vacuum-compatible processing chamber may comprise any material that is thermally compatible with the at least one effusion cell, the at least one thermal cracker cell, the at least one heat block or cold block used to control the temperature of the rotating conveyor belt, and the plasma plume generated in the applied electric field between the anode and cathode, and is chemically compatible with the alkali-metal, elemental sulfide, and the formed alkali-metal sulfide material.

While there are no limits to the size and shape of a vacuum-compatible processing chamber used in the manufacturing of alkali-metal sulfide materials, whether heat-assisted or plasma-assisted, that would restrict the scope of the method, the processing chamber has a preferred volume in the range of 1≤V≤10,000 liters or 0.001≤V≤10 cubic meters.

While the description herein describes a system in the preferred volume range of 1≤V≤25,000 liters or 0.001≤V≤25 cubic meters, it should be noted that chambers may be sufficient enough in size to allow human entry and with an interior best described as the size of a standard room to a small or medium-sized building with volumes that far exceed, with no restrictive limits, great than 25 cubic meters.

The vacuum-compatible processing chamber may be described as an upside-down bell-shaped chamber with a flat top and a curved bottom. Alternatively, the processing chamber may be more tubular with a flat top and a flat bottom.

The vacuum-compatible processing chamber may have a latched door on top that opens to the exterior of the chamber to allow the removal of the processed and collected alkali-metal sulfide material.

The present description relates to the at least one effusion cell used for manufacturing alkali-metal sulfide materials.

A vacuum-compatible processing chamber may comprise one or more effusion cells used for the evaporation of alkali-metal as part of the method for manufacturing alkali-metal sulfides.

The one or more effusion cells may have a reservoir or heat sink, exterior of the processing chamber, serving as a passive heat exchanger that transfers the heat generated by the heating element to the outside air or a liquid coolant, where it is dissipated away from the cell, thereby allowing regulation of the effusion cells temperature.

The one or more effusion cells may have a filament port, exterior of the processing chamber, for delivering current to the heating elements inside the cell.

The one or more effusion cells may have a thermocouple port, exterior of the processing chamber, that allows a thermocouple to be inserted for monitoring cell temperature.

The one or more effusion cells may have a chilled water or antifreeze port, exterior of the processing chamber, that allows for cooling and temperature regulation.

The one or more effusion cells may have a mounting flange with a diameter in the range of 2≤D≤1000 cm, with a preferred range of 4≤D≤25 cm. The mounting flange should match the size of the mounting flange on the processing chamber. Alternatively, an adaptor may be used if the flange sizes are different.

The one or more effusion cells may have a tube comprising, for example, the heating elements, cooling lines, and ceramic crucibles.

The one or more effusion cells may comprise a ceramic crucible with a diameter in the range of 1≤D≤99 cm, with a preferred range of 2≤D≤30 cm. The ceramic crucible may comprise of, for example, alumina, silicon carbide, zirconia, graphite, magnesium oxide, etc.

The one or more effusion cells may comprise a ceramic crucible with an elliptical cone with a round bottom.

The one or more effusion cells may have a shutter on the open end to control the alkali-metal flux. The shutter position may be controlled through a computer or automation.

The one or more effusion cells may operate in a temperature range of 200≤T≤1500° C.

The one or more effusion cells may be orientated as follows. Briefly, the one or more effusion cells have an axis that runs along the center of the tube through the crucible and into the processing chamber. In a heat-assisted approach, this axis may have a point of intersection with the axis of the one or more thermal cracker cells preferably at the surface of the rotating conveyor belt. More specifically, the point of intersection may be at the center of the belt equal distance from the axis of both pulley wheels. Alternatively, the point of intersection may not be at the surface of the rotating conveyor belt and is closer to one of the pulley wheels than the other. In a plasma-assisted approach, the axis may have a point of intersection with the axis of the one or more thermal cracker cells preferably at the center of the electric field between the at least one cathode and one anode or at the surface of the rotating conveyor belt. Alternatively, the point of intersection may not be at the center of the electric field and is closer to either the cathode or anode.

The present description relates to the at least one thermal cracker cell used for manufacturing alkali-metal sulfide materials.

A vacuum-compatible processing chamber may comprise one or more thermal cracker cells used for the evaporation of alkali-metal as part of the method for manufacturing alkali-metal sulfides.

The one or more thermal cracker cells may have a reservoir or heat sink, exterior of the processing chamber, serving as a passive heat exchanger that transfers the heat generated by the heating elements to the outside air or a liquid coolant, where it is dissipated away from the cell, thereby allowing regulation of the thermal cracker cells temperature.

The one or more thermal cracker cells may have a filament port, exterior of the processing chamber, for delivering current to the heating elements inside the cell.

The one or more thermal cracker cells may have a thermocouple port, exterior of the processing chamber, that allows a thermocouple to be inserted for monitoring cell temperature.

The one or more thermal cracker cells may have a chilled water or antifreeze port, exterior of the processing chamber, that allows for cooling and temperature regulation.

The one or more thermal cracker cells may have a mounting flange with a diameter in the range of 2≤D≤1000 cm, with a preferred range of 4≤D≤25 cm. The mounting flange should match the size of the mounting flange on the processing chamber. Alternatively, an adaptor may be used if the flange sizes are different.

The one or more thermal cracker cells may have a tube comprising, for example, the heating elements, cooling lines, and ceramic crucibles.

The one or more thermal cracker cells may comprise a ceramic crucible with a diameter in the range of 1≤D≤99 cm, with a preferred range of 23D≤30 cm. The ceramic crucible may comprise of, for example, alumina, silicon carbide, zirconia, graphite, magnesium oxide, etc.

The one or more thermal cracker cells may comprise a ceramic crucible with an elliptical cone with a round bottom.

The one or more thermal cracker cells may comprise a cracker head to control the sulfur flux and reduce corrosion inside the processing chamber. A cracker head may be cooled with integrated water cooling.

The one or more thermal cracker cells may have a shutter on the open end to control the alkali-metal flux. The shutter position may be controlled through a computer or automation.

The one or more thermal cracker cells may operate in a temperature range of 100≤T≤900° C.

The one or more thermal cracker cells may be orientated as follows. Briefly, the one or more thermal cracker cells have an axis that runs along the center of the tube through the crucible and into the processing chamber. In a heat-assisted approach, this axis may have a point of intersection with the axis of one or more effusion cells preferably at the surface of the rotating conveyor belt. More specifically, the point of intersection may be at the center of the belt equal distance from the axis of both pulley wheels. Alternatively, the point of intersection may not be at the surface of the rotating conveyor belt and is closer to one of the pulley wheels. In a plasma-assisted approach, the axis may have a point of intersection with the axis of the one or more effusion cells preferably at the center of the electric field between the at least one cathode and one anode or at the surface of the conveyor belt. Alternatively, the point of intersection may not be at the center of the electric field and is closer to either the cathode or anode.

The present description relates to the at least one rotating conveyor belt system used for manufacturing alkali-metal sulfide materials.

A vacuum-compatible processing chamber may comprise one or more rotating conveyor belt systems used to collect deposited alkali metal and elemental sulfur in a heat-assisted processing approach for the manufacturing of alkali-metal sulfides.

A vacuum-compatible processing chamber may comprise one or more rotating conveyor belt systems used to collect alkali-metal sulfide and residual alkali-metal and elemental sulfur in a plasma-assisted processing approach for the manufacturing of alkali-metal sulfides.

The one or more rotating conveyor belt systems may comprise a single rotating conveyor belt, two or more pulley wheels that govern the rotation of the belt, a temperature-controlled block between the single rotating conveyor belt, and a knife or blade to remove the alkali-metal sulfides.

The following characteristics describe the single-rotating conveyor belt.

The single rotating conveyor belt may be comprised of, for example, polyester, polyethylene terephthalate (PET), polyetherimide (PEI), polyether ether ketone (PEEK), polytetrafluoroethylene (PTFE), polyphenylene sulfide, polyamide-imide (PAI), polysulfone (PSU), polydicyclopentadiene (pDCPD), polybenzimidazole (PBI), silicone, nitrile rubber (Buna-N), Teflon, Mylar, Vespel, Ultem, Torlon, etc.

Alternatively, the single rotating conveyor belt may be metallic with a high temperature resin or thin ceramic coating on top to protect against sulfur corrosion.

In yet another alternative, the single rotating conveyor belt may comprise any material or combination of materials flexible enough to withstand the forces applied by the two or more pulley wheels while thermally compatible with the processing temperatures within the processing chamber and chemically compatible with alkali-metal, elemental sulfur, alkali-metal sulfide, and any ionic species generated inside the plasma plume in the case of a plasma-assisted approach.

The single rotating conveyor belt may have two sides: Side A which faces the at least one effusion and thermal cracker cells, and Side B which comes in physical contact with the two or more pulley wheels.

It is preferred that the surface of Side A be flat so that the deposited material layer can be removed with a knife or blade. Alternatively, Side A may not be flat, wherein any surface features are compatible with the knife or blade edge needed to remove the material layer.

Side B may be flat or have features, such as grooves, that allow it to rotate with the two or more pulley wheels.

The following characteristics describes the two or more pulley wheels that govern the rotation of the single rotating conveyor belt.

The two or more pulley wheels may be comprised of stainless steel.

Alternatively, the two or more pulley wheels may comprise any material thermally compatible with the processing temperatures within the processing chamber and chemically compatible with alkali-metal, elemental sulfur, alkali-metal sulfide, and any ionic species generated inside the plasma plume in the case of a plasma-assisted approach.

Briefly, the single rotating conveyor belt rotates around two or more pulley wheels, preferably two, that govern and control the rotation rate of the belt. The two or more pulley wheels may be described as a sheave with grooves that keep the conveyor belt in place. Alternatively, the two or more pulley wheels may be described as a cylinder or roller that is designed to keep tension on the single rotating conveyor belt. In yet another alternative, the pulley wheels may have any design or features that allow for them to operate in the manufacturing process of alkali-metal sulfides and therefore have no restrictions. Moreover, the two or more pulley wheels may have different features. A detailed discussion of the designs and features of which are beyond the scope of this disclosure.

The diameter of the two or more pulley wheels and the distance between the axis of the two or more pulley wheels may vary widely and are governed by the size of the processing chamber or system. Moreover, the diameter of the two or more pulley wheels may be the same or different. Therefore, there is no restriction on the size of the pulley wheels, the number of pulley wheels, or the distance between them. However, the diameter of the two or more pulley wheels and the distance between the two axes may govern the length of the belt and the rotation speed. Therefore, the two or more pulley wheels may rotate at a rotation per second or rotation per minute rate needed to reach a conveyor belt rate in the range of 0≤t≤1000 mm per second, with a preferred range of 0≤t≤10 mm per second.

The rotation of the two or more pulley wheels may be automated and controlled using a computer external to the processing system. The rotation of the conveyor belt may be constant or vary depending on the processing needs. Moreover, there may be interment stops in the rotation to allow the build-up of the materials layer on the surface.

The rotation of the two or more pulley wheels is preferably clockwise. However, the two or more pulley wheels may rotate counterclockwise depending on the setup of the processing chamber.

The following characteristics describes the one or more temperature-controlled blocks between the single rotating conveyor belt.

A rotating conveyor belt system comprises one or more temperature-controlled blocks between the single rotating conveyor belts. The one or more temperature-controlled blocks have two sides: Side 1 which faces up toward the top or latched door of the processing chamber and Side 2 which faces down toward the at least one effusion and thermal cracker cells.

Side 2 of the temperature-controlled block is preferably in physical contact with Side B of the conveyor belt, wherein the temperature of the block is transferred to the conveyor belt through thermal conduction.

Alternatively, a temperature-controlled block may not be in physical contact with Side B of the conveyor belt, wherein the temperature of the block is transferred to the conveyor belt through radiation. In such an instance it is assumed that the temperature-controlled block and conveyor belt are still in close proximity.

Side 1 of the temperature-controlled block may also be in Physical contact with Side B of the conveyor belt or in close proximity thereof.

A temperature-controlled block may be a heat block used to drive the reaction between alkali metal and elemental sulfur deposited on the surface of the conveyor belt. A heat block may be used in both heat-assisted and plasma-assisted processing.

A heat block may have a temperature in the range of 0≤T≤2000° C., with a preferred range of 100≤T≤1000° C.

A heat block is preferably heated using resistive heating, wherein the current supplied to the block is controlled through a mechanism external to the processing chamber.

The temperature of a heat block may be constant and kept at a set point or vary within a range. When varied in a range it may oscillate at a constant rate or have different set points within the range.

A temperature-controlled block may be a cold block used to quench the alkali-metal sulfide to enhance crystal structure and reduce particle size. It is anticipated that a cold block is primarily used in plasma-assisted processing to quench the less packed particles, with respect to the layer formed using heat-assisted processing, on the surface of the conveyor belt However, in some instances, a cold block may also be used in heat-assisted processing.

A col −block may have a temperature in the range of −270≤T≤500° C., with a preferred range of-200≤T≤100° C.

The temperature of the cold block may be controlled by, for example, chilled water, antifreeze, dry ice, liquid nitrogen, or a combination thereof.

The temperature of a cold block may be constant and kept at a set point or vary within a range. When varied in a range it may oscillate at a constant rate or have different set points within the range.

A processing chamber may comprise both a heat block and a cold block between the rotating conveyor belt. In such an instance, it is anticipated that Side B of the rotating conveyor belt will first come in contact with Side 2 of the heat block followed by Side 2 of the cold block.

Additional temperature-controlled blocks may also be positioned above the rotating conveyor belt, wherein Side 2 of the block comes into contact with Side A of the rotating conveyor belt for better or more constant temperature control.

The temperature of a temperature-controlled block may be governed by the temperature of the conveyor belt using a thermocouple and feedback loop. For example, the thermocouple may be in contact with Side A of the conveyor belt. The thermocouple and temperature-controlled block are controlled through the same computerized system external to the processing chamber. The system has a set temperature point the rotating conveyor belt needs to reach to either drive the reaction or alkali-metal sulfide or quench the alkali-metal sulfide. The temperature of the block will be adjusted to reach the set temperature point.

The following characteristics describe the knife or blade used to remove the formed alkali-metal sulfide on the surface of the conveyor belt.

The knife or blade may be positioned over one of the two or more pulley wheels and in physical contact with Side A of the conveyor belt to remove the alkali-metal sulfide.

The pulley wheel in which the knife or blade is positioned over may have a larger diameter to enhance the removal of alkali-metal sulfide.

The knife or blade may be composed of stainless steel and have a V or flat ground edge, a convex edge, an asymmetrical V or flat ground edge, a chisel or single bevel, etc.

Alternatively, the knife or blade may comprise any material with the mechanical properties sufficient to remove the alkali-metal sulfide, thermally compatible with the processing temperatures within the processing chamber and chemically compatible with alkali-metal, elemental sulfur, alkali-metal sulfide, and any ionic species generated inside the plasma plume in the case of a plasma-assisted approach.

The knife or blade may be connected to a computer-controlled or automated lever which allows it to detach or move away from the single rotating conveyor belt. In this instance, the knife or blade is moved away from the single rotating conveyor belt to allow the buildup of the alkali-metal sulfide on the surface. When the buildup reaches a set thickness or a sufficient amount of time has passed, the knife or blade will be retracted and brought into contact with the single rotating conveyor belt.

The present description relates to the at least one collection crucible used for manufacturing alkali-metal sulfide materials.

A vacuum-compatible processing chamber may comprise at least one collection crucible at the bottom of the processing chamber used to collect alkali-metal sulfides as part of the manufacturing method.

It is preferred that the processing chamber comprises one large collection crucible at the bottom that can be transferred in and out of the system through the latched door on top. Moreover, it is assumed that the collection crucible is designed or customized to fit the curvature of the collection chamber to ensure the highest yield of collected alkali-metal sulfide.

The collection crucible may have a rotation feature wherein it is connected to and supported by a gearbox positioned outside of the processing chamber. The rotation feature may enhance the collection of alkali-metal sulfide.

The at least one collection crucible may be comprised entirely of, for example, alumina, silicon carbide, zirconia, graphite, magnesium oxide, etc.

For larger processing chambers, the collection crucible may comprise a stainless-steel bottom with a ceramic coating on top, wherein the stainless-steel bottom can be pulled out of the processing chamber through the latched door using an external pulley system.

The ceramic top may comprise, for example, alumina, silicon carbide, zirconia, graphite, magnesium oxide, etc.

The present description relates to the at least one plasma generation system in plasma-assisted processing.

A vacuum-compatible processing chamber may comprise at least one plasma generation system for plasma-assisted processing.

A plasma generation system may comprise at least one cathode, at least one anode, and a power source external to the processing chamber. The external power source may be connected to at least one cathode and one anode.

The distance between the at least one cathode and one anode may have a distance in the range of 1≤D≤10,000 cm, with a preferred range of 5≤D≤1,000 cm.

The electric field generated between the at least one cathode and one anode may have a strength in the range of 0≤P≤100,000 kilovolts per meter (kV/m).

A plasma plume may be generated between the at least one cathode and one anode when an electric field is generated therebetween and elemental sulfur and alkali-metal in the gaseous phase are present.

Preferably, a DC voltage may be applied across the at least one cathode and one anode. Alternatively, an AC voltage may be applied in certain situations or applications where an alternating voltage field is desired.

The at least one cathode and one anode may be positioned between Side A of the rotating conveyor belt and the collection crucible.

The present disclosure relates to alkali-metal sulfide and other materials of similar nature.

An alkali-metal sulfide may have the chemical formula M₂S where M is preferably Li, Na, or K. However, it is also understood that M may also be Cs, Rb, or Fr, or a mixed metal sulfide of two or more of Li, Na, K, Cs, and Fr.

Alkali-metal sulfide material may include, for example, lithium sulfide (Li₂S), sodium sulfide (Na₂S), potassium sulfide (K₂S), cesium sulfide (Cs₂S), rubidium sulfide (Rb₂S), and francium sulfide (Fr₂S).

The alkali-metal sulfide powder may be characterized by a median particle size (D50) of 0.01 μm to 10,000 μm, preferably 0.1≤D≤1000 μm.

A heat-assisted processing approach for the manufacturing of alkali-metal sulfides may result in a D50 particle size in the range of 0.015≤D≤10,000 μm, with a preferred range of 0.15≤D≤1000 μm.

In plasma-assisted processing, the average D50 particle size of the resulting alkali-metal sulfide is expected to be lower than the average D50 particle size of the resulting alkali-metal sulfide produced via heat-assisted processing. A plasma-assisted processing approach for the manufacturing of alkali-metal sulfides may result in a D50 particle size in the range of 0.01≤D≤10,000 μm, with a preferred range of 0.1≤D≤500 μm.

Particle size may be controlled by 1) controlling the flux of the alkali-metal, 2) controlling the flux of the elemental sulfur, 3) adjusting the electric field strength between the cathode and anode, 4) enhancing quenching efficiency or rate of a cold block, or 5) a combination thereof.

The alkali-metal sulfide powder may be characterized by a narrow particles size distribution. In an example, a heat-assisted processing approach for the manufacturing of alkali-metal sulfides may result in a D10 value may be at least 5% of the D50 value and a D90 value may be no more than 300% of the D50 value. In another example, a plasma-assisted processing approach for the manufacturing of alkali-metal sulfides may result in the D10 value may be at least 50% of the D50 value and the D90 value may be no more than 200% of the D50 value. The plasma-assisted processing approach for the manufacturing of alkali-metal sulfides may enable a narrower particle size distribution and a smaller particle size to be achieved.

The alkali-metal sulfide powder may be characterized by a relatively spherical morphology. In an example, a heat-assisted processing approach for the manufacturing of alkali-metal sulfides may result in the alkali-metal sulfide powder having a morphology wherein over 50 wt % of the particles exhibit a sphericity index greater than 0.7. In another example, a plasma-assisted processing approach for the manufacturing of alkali-metal sulfides may result in the alkali-metal sulfide powder having a morphology wherein over 50 wt % of the particles exhibit a sphericity index greater than 0.8.

The alkali-metal sulfide powder may be characterized by a high purity. In an aspect, the alkali-metal sulfide powder may have a purity of at least 99% by weight, preferably at least 99.5% by weight, more preferably at least 99.9% by weight.

The method for manufacturing alkali-metal sulfide materials may also extend to other chalcogenide materials comprising an alkali-metal such as, for example, lithium selenide (Li₂Se), sodium selenide (Na₂Se), potassium selenide (K₂Se), cesium selenide (Cs₂Se), rubidium selenide (Rb₂Se), francium selenide (Fr₂Se), lithium telluride (Li₂Te), sodium telluride (Na₂Te), potassium telluride (K₂Te), cesium telluride (Cs₂Te), rubidium telluride (Rb₂Te), and francium telluride (Fr₂Te), wherein the sulfur is replaced with another non-oxide chalcogen or group 16 metal that is non-radioactive in the thermal cracker cell.

The method for manufacturing alkali-metal sulfide material may also extend to other chalcogenide materials comprising non-alkali-metals with a boiling point below 1500° C. including for example, calcium sulfide (CaS), barium sulfide (BaS), magnesium sulfide (MgS), zinc sulfide (ZnS), cadmium sulfide (CdS), phosphorous sulfide (P₂S₃, P₂S₅, P₄Sₙ with n≤10), calcium selenide (CaSe), barium selenide (BaSe), magnesium selenide (MgSe), zinc selenide (ZnSe), cadmium selenide (CdSe), phosphorous selenide (P₂Se₃, P₂Se₅, P4Seₙ with n≤10), calcium telluride (CaTe), barium telluride (BaTe), magnesium telluride (MgTe), zinc telluride (ZnTe), cadmium telluride (CdTe), and phosphorous telluride (P₂Te₃, P₂Te₅, P₄Teₙ with n≤10), wherein the alkali-metal is replaced with a non-alkali-metal in the effusion cell.

The method for manufacturing alkali-metal sulfide materials may also extend to oxygen-based chalcogenide materials comprising of alkali-metals, or non-alkali-metals with a boiling point below 1500° C. include, for example, lithium oxide (Li₂O), sodium oxide (Na₂O), potassium oxide (K₂O), cesium oxide (Cs₂O), rubidium oxide (Rb₂O), francium oxide (Fr₂O), calcium oxide (CaO), barium oxide (BaO), magnesium oxide (MgO), zinc oxide (ZnO), cadmium oxide (CdO), and phosphorous oxide (P₂O₃, P2O₅, P₄Oₙ with n≤10), wherein the thermal cracker cell is replaced with an oxygen gas inlet.

The drawings of the present disclosure further describe the system for alkali-metal sulfide production.

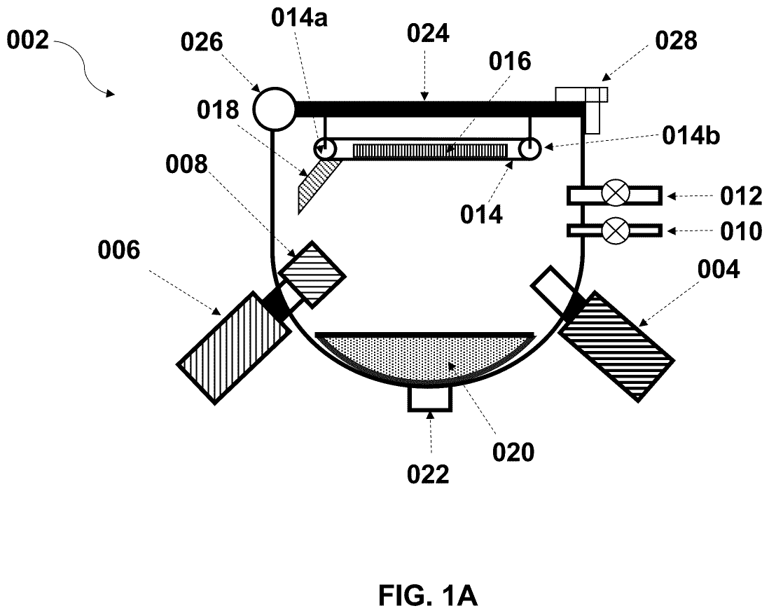

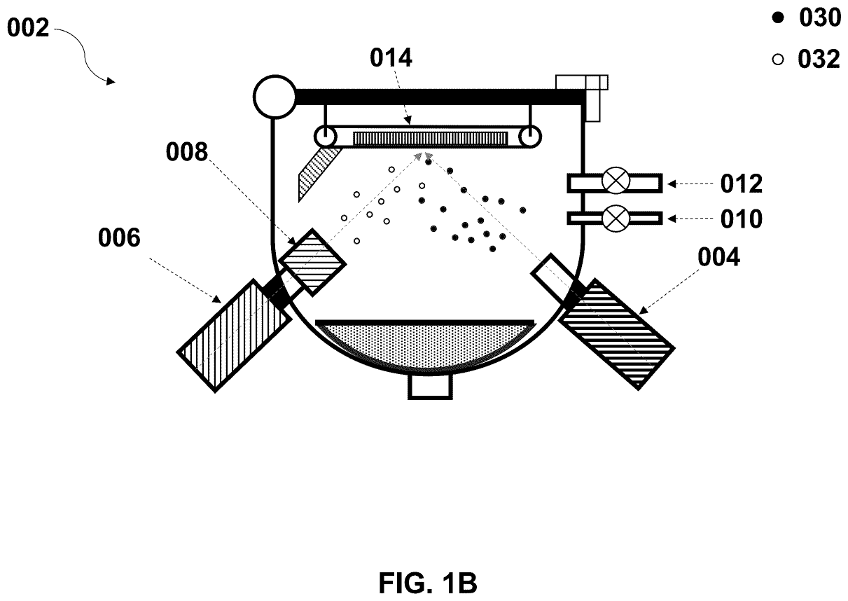

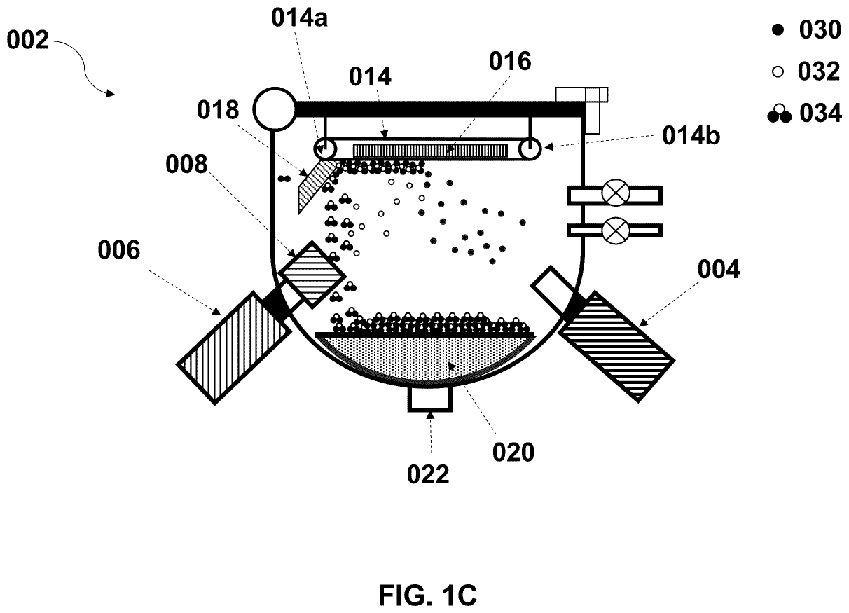

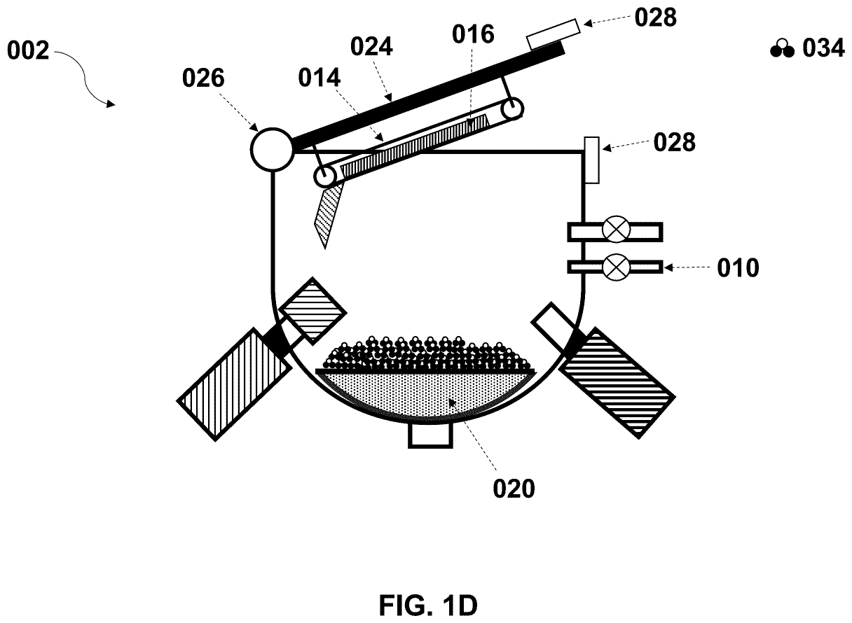

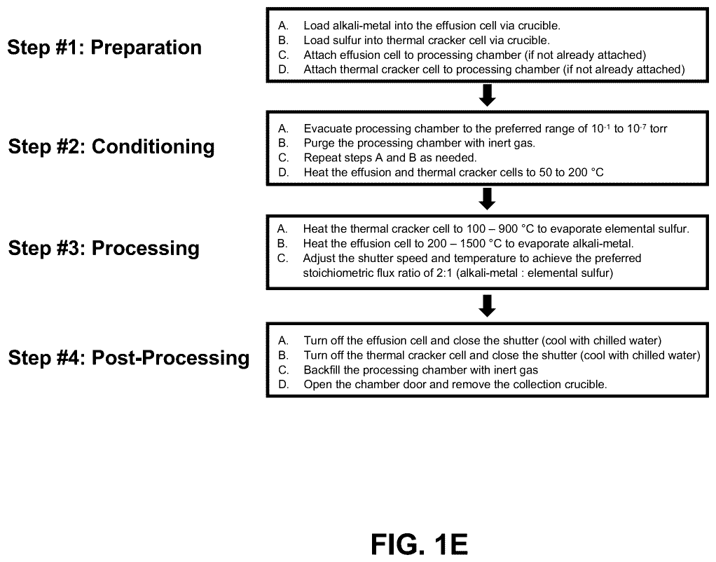

FIG. 1A: A schematic illustration of the heat-assisted processing approach prior to the manufacturing of alkali-metal sulfide materials. The heat-assisted approach comprises an upside-down bell-shaped vacuum-compatible processing chamber (002) further comprising one effusion cell (004) for the evaporation of alkali-metal, one thermal cracker cell (006) with a cracker head (008) for the evaporation of elemental sulfur, an inert gas inlet (010) for chamber purging, a vacuum inlet (012) for chamber evacuation, a rotating conveyor belt (014), controlled by two pulley wheels (014a and 014b) to collect alkali metal and elemental sulfur, a heat block between the rotating conveyor belt (016) to drive the formation of alkali-metal sulfide using the deposited alkali metal and elemental sulfur, a knife/blade (018) to remove the formed alkali-metal sulfide from the rotating conveyor belt (016), and a collection crucible (020) connected to a rotating gearbox (022) located at the bottom of the processing chamber to collect the alkali-metal sulfide. The illustration further comprises a chamber door on top (024), along with a latch (026) and hinge (028), to remove the alkali-metal sulfide.

FIG. 1B: A schematic illustration of the heat-assisted processing approach during the manufacturing of alkali-metal sulfide materials. The heat-assisted approach comprises a vacuum-compatible processing chamber (002) further comprising an inert gas (010) and vacuum (012) inlet for chamber purging and evacuation to remove moisture, oxygen, and other potential contaminants prior to the manufacturing of alkali-metal sulfides. The vacuum-compatible processing chamber (002) further comprises one effusion cell (004) for the evaporation of alkali-metal in elemental form (030) and one thermal cracker cell (006) with a cracker head (008) for the evaporation of elemental sulfur (032). The schematic further illustrates 1) the orientation and direction of the effusion (004) and thermal cracker (006) cells in relation to the rotating conveyor belt (014) (gray arrows) and 2) the preferred 2:1 alkali metal (030) to elemental sulfur (032) stoichiometric relationship of the flux needed to make M₂S (where M is Li, Na, or K).

FIG. 1C: A schematic illustration of the heat-assisted processing approach during the manufacturing of alkali-metal sulfide materials. The heat-assisted approach comprises a vacuum-compatible processing chamber (002) further comprising one effusion cell (004) for the evaporation of alkali-metal in elemental form (030), one thermal cracker cell (006) with a cracker head (008) for the evaporation of elemental sulfur (032), a rotating conveyor belt (014) for the collection of the alkali-metal (030) and elemental sulfur (032). A heat block (016), between the rotating conveyor belt (014), is used to form alkali-metal sulfide (034) by thermally treating the deposited alkali-metal (030) and element sulfur (032). The formed alkali-metal sulfide (034) is removed from the rotating conveyor belt (014) using a knife or blade (018). The rotating conveyor belt (014) is in physical contact with the knife or blade (018), wherein the belt is rotated over the edge of the knife or blade (018) to remove the alkali-metal sulfide (034), wherein the rotation of the belt is controlled by the two pulley wheels (014a and 014b) shown in the illustration. The alkali-metal sulfide is collected in the collection crucible (020) at the bottom of the processing chamber (002). The collection crucible may rotate, controlled by the gearbox (022) outside the processing chamber (002), to fully utilize the entire crucible volume.

FIG. 1D: A schematic illustration of the heat-assisted processing approach after the manufacturing of alkali-metal sulfide materials has concluded. The heat-assisted approach comprises a vacuum-compatible processing chamber (002) further comprising an inert gas inlet (010) to backfill the chamber and bring it to atmospheric pressure. The processing chamber (002) further comprises a chamber door on top (024) that unlatches from the chamber (via latch 028) and opens to the external environment (via hinge 026). The external environment is preferably a dry room with a moisture content below 1000 ppm or an inert atmosphere in a glovebox. The schematic further illustrates that the rotating conveyor belt (014) and heat block (016) are attached to the chamber door (024), the specific details of which with regards to how they are attached are beyond the scope of this disclosure. The collection crucible (020) containing the alkali-metal sulfide (034) may be removed from the processing chamber (002) out through the top.

FIG. 1E: A flowchart of the heat-assisted alkali-metal sulfide manufacturing process comprising four overarching steps: Preparation (Step #1), Conditioning (Step #2), Processing (Step #3), and Post-Processing (Step #4). Each step contains one or more sub-steps outlined below.

Preparation (Step #1) comprises four sub-steps including loading alkali-metal into the at least one effusion cell via crucible (1A), loading elemental sulfur into the at least one thermal cracker cell via crucible (1B), loading the at least one effusion cell to the processing chamber and sealing (1C), loading the at least one thermal cracker cell to the processing chamber and sealing (1D). Note that 1C and 1D may not be needed if the cells are already loaded onto the processing chamber and sealed.

Conditioning (Step #2) comprises three sub-steps including evacuating the processing chamber to the preferred vacuum range of 10⁻¹ to 10⁻⁷ torr (2A), purging or backfilling the processing chamber with an inert gas (2B), and heating the at least one effusion and thermal cracker cells to 50≤T≤200° C. to remove potential contamination (2C). Note that 2A and 2B may be repeated through multiple iterations to achieve the desired processing conditions.

Processing (Step #3) comprises three sub-steps including heating the at least one thermal cracker cell to the temperature range of 100≤T≤900° C. to evaporate elemental sulfur (3A), heating the at least one effusion cell to the temperature range of 200≤T≤1500° C. to evaporate alkali-metal (3B), and adjusting the shutter speed and temperature of the at least one effusion and thermal cracker cells to achieve the preferred (alkali-metal to elemental sulfur) stoichiometric flux ratio of 2:1 (3C).

Post-Processing (Step #4) comprises four sub-steps including closing the shutter and turning off the at least one effusion cell to terminate the evaporation of alkali-metal (4A), closing the shutter and turning off the at least one thermal cracker cell to terminate the evaporation of elemental sulfur (4B), backfilling the processing chamber with inter gas to bring to atmospheric pressure (4C), and opening the chamber door to remove the collection crucible (4D). Note that the at least one effusion and thermal cracker cells may be cooled with chilled water or antifreeze.

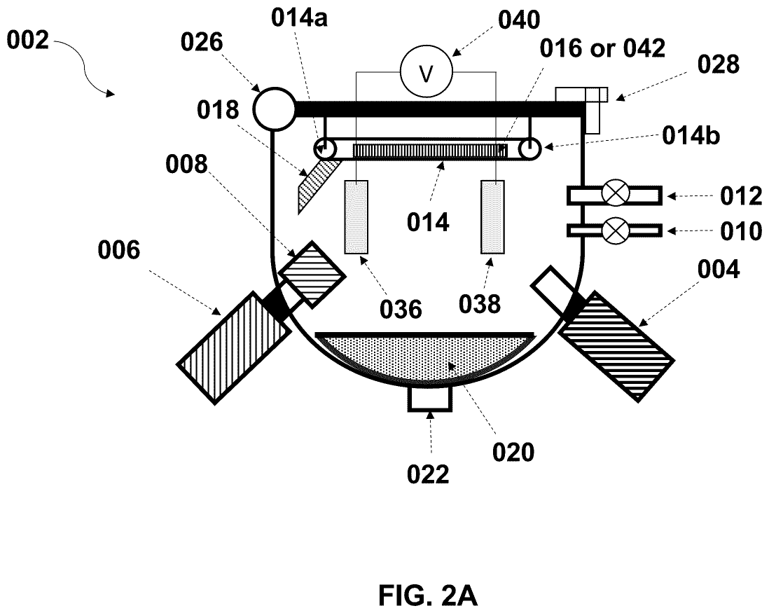

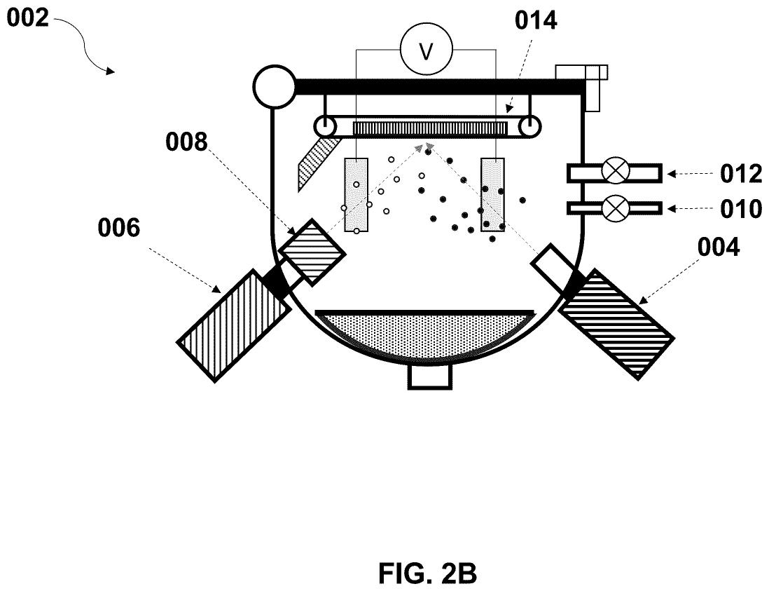

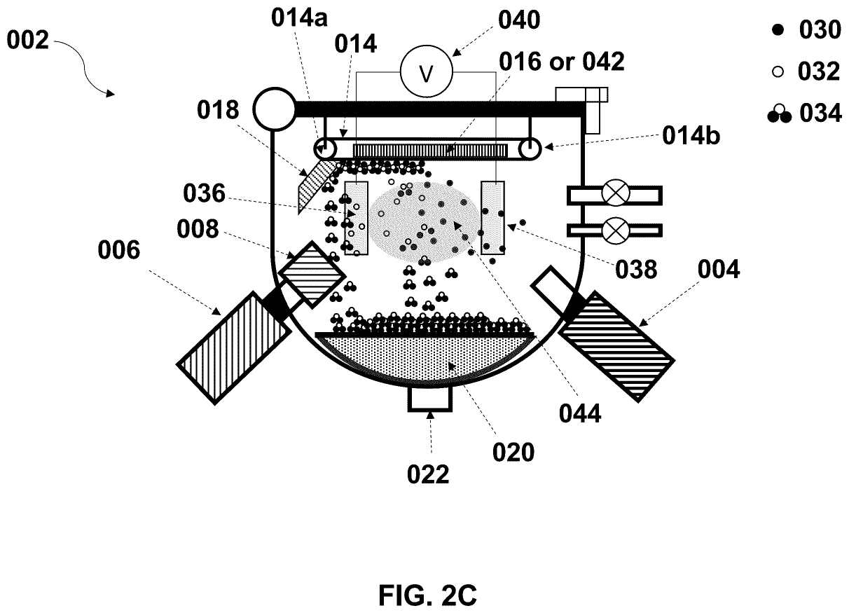

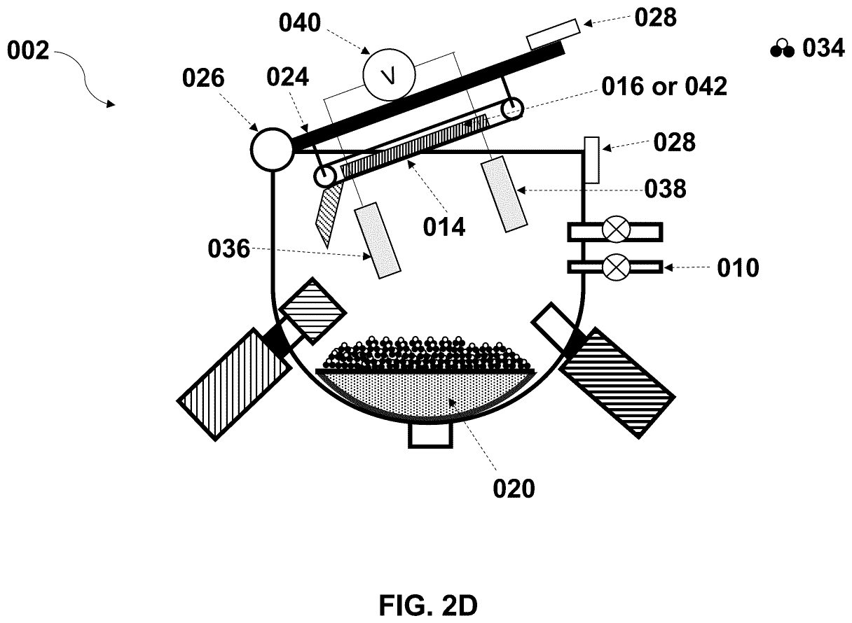

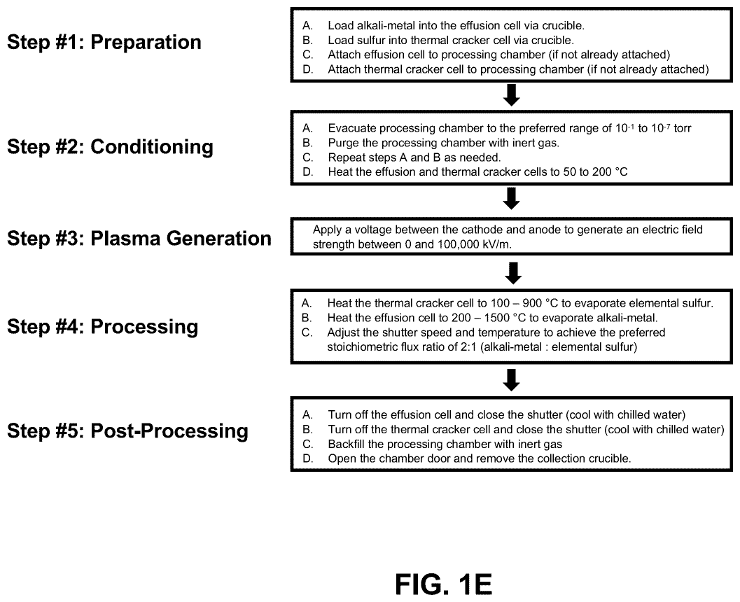

FIG. 2A: A schematic illustration of the plasma-assisted processing approach prior to the manufacturing of alkali-metal sulfide materials. The plasma-assisted approach comprises an upside-down bell-shaped vacuum-compatible processing chamber (002) further comprising one effusion cell (004) for the evaporation of alkali-metal, one thermal cracker cell (006) with a cracker head (008) for the evaporation of elemental sulfur, an inert gas inlet (010) for chamber purging, a vacuum inlet (012) for chamber evacuation, a cathode (038) and anode (036) connected to a voltage source (040) for plasma generation, a rotating conveyor belt (014), controlled by two pulley wheels (014a and 014b) to collect alkali-metal sulfide, a heat (016) or cold (042) block between the rotating conveyor belt to further drive the formation of alkali-metal sulfide of any deposited alkali metal and elemental sulfur or quench the formed alkali-sulfide, a knife or blade (018) to remove the formed alkali-metal sulfide from the rotating conveyor belt (016), and a collection crucible (020) connected to a rotating gear box (022) located at the bottom of the processing chamber to collect the alkali-metal sulfide. The illustration further comprises a chamber door on top (024), along with a latch (026) and hinge (028), to remove the alkali-metal sulfide.

FIG. 2B: A schematic illustration of the plasma-assisted processing approach during the manufacturing of alkali-metal sulfide materials. The plasma-assisted approach comprises a vacuum-compatible processing chamber (002) further comprising an inert gas (010) and vacuum (012) inlet for chamber purging and evacuation to remove moisture, oxygen, and other potential contaminants prior to the manufacturing of alkali-metal sulfides. The vacuum-compatible processing chamber (002) further comprises one effusion cell (004) for the evaporation of alkali-metal in elemental form (030) and one thermal cracker cell (006) with a cracker head (008) for the evaporation of elemental sulfur (032). The schematic further illustrates 1) the orientation and direction of the effusion (004) and thermal cracker (006) cells in relation to the rotating conveyor belt (014) (gray arrows) and 2) the preferred 2:1 alkali metal (030) to elemental sulfur (032) stoichiometric relationship of the flux needed to make alkali-metal sulfide.

FIG. 2C: A schematic illustration of the plasma-assisted processing approach during the manufacturing of alkali-metal sulfide materials. The plasma-assisted approach comprises a vacuum-compatible processing chamber (002) further comprising one effusion cell (004) for the evaporation of alkali-metal in elemental form (030), one thermal cracker cell (006) with a cracker head (008) for the evaporation of elemental sulfur (032), and a cathode (038) and anode (036) connected to an external power source (040) to generate an electric field. A plasma plume (044) is generated between the cathode (038) and anode (036), wherein alkali-metal sulfide (034) is formed. A portion of the alkali-metal sulfide (034) may be deposited directly into the collection crucible (020) at the bottom of the processing chamber (002). Alternatively, the formed alkali-metal sulfide (034), as well as residual alkali-metal (030) and elemental sulfur (032), may be deposited on the rotating conveyor belt (014). A heat block (016) between the rotating conveyor belt (014), may be used to form alkali-metal sulfide (034) by thermally treating the residual alkali-metal (030) and elemental sulfur (032) on the surface of the conveyor belt (014). Alternatively, a cold block (042) may rapidly quench the deposited alkali-metal sulfide to further reduce particle size. The formed alkali-metal sulfide (034) is removed from the rotating conveyor belt (014) using a knife or blade (018). The rotating conveyor belt (014) is in physical contact with the knife or blade (018), wherein the belt is rotated over the edge of the knife or blade (018) to remove the alkali-metal sulfide (034), wherein the rotation of the belt is controlled by the two pulley wheels (014a and 014b) shown in the illustration. The alkali-metal sulfide is collected in the collection crucible (020) at the bottom of the processing chamber (002). The collection crucible may rotate, controlled by the gearbox (022) outside the processing chamber (002), to fully utilize the entire crucible volume.

FIG. 2D: A schematic illustration of the plasma-assisted processing approach after the manufacturing of alkali-metal sulfide materials has concluded. The plasma-assisted approach comprises a vacuum-compatible processing chamber (002) further comprising an inert gas inlet (010) to backfill the chamber and bring it to atmospheric pressure. The processing chamber (002) further comprises a chamber door on top (024) that unlatches from the chamber (via latch 028) and opens to the external environment (via hinge 026). The external environment is preferably a dry room with a moisture content below 1000 ppm or an inert atmosphere in a glovebox. The schematic further illustrates that the rotating conveyor belt (014), a heat (016) or cold (042) block, the cathode (038), and the anode (036) are attached to the chamber door (024), the specific details of which with regards to how they are attached are beyond the scope of this disclosure. The collection crucible (020) containing the alkali-metal sulfide (034) may be removed from the processing chamber (002) out through the top.

FIG. 2E: A flowchart of the plasma-assisted alkali-metal sulfide manufacturing process comprising five overarching steps: Preparation (Step #1), Conditioning (Step #2), Plasma Generation (Step #3), Processing (Step #4), and Post-Processing (Step #5). Each step contains one or more sub-steps outlined below.

Preparation (Step #1) comprises four sub-steps including loading alkali-metal into the at least one effusion cell via crucible (1A), loading elemental sulfur into the at least one thermal cracker cell via crucible (1B), loading the at least one effusion cell to the processing chamber and sealing (1C), loading the at least one thermal cracker cell to the processing chamber and sealing (1D). Note that 1C and 1D may not be needed if the cells are already loaded onto the processing chamber and sealed.

Conditioning (Step #2) comprises three sub-steps including evacuating the processing chamber to the preferred vacuum range of 10-1 to 10-7 torr (2A), purging the processing chamber with an inert gas (2B), and heating the at least one effusion and thermal cracker cells to 50≤T≤200° C. to remove potential contamination (2C). Note that 2A and 2B may be repeated through multiple iterations to achieve the desired processing conditions.

Plasma Generation (Step #3) comprises applying a voltage between the at least one cathode and one anode using an external power source to generate an electric field with a strength between 0 and 100,000 kV/m.

Processing (Step #4) comprises three sub-steps including heating the at least one thermal cracker cell to the temperature range of 100≤T≤900° C. to evaporate elemental sulfur (4A), heating the at least one effusion cell to the temperature range of 200≤T≤1500° C. to evaporate alkali-metal (4B), and adjusting the shutter speed and temperature of the at least one effusion and thermal cracker cells to achieve the preferred (alkali-metal to elemental sulfur) stoichiometric flux ratio of 2:1 (4C).

Post-Processing (Step #5) comprises four sub-steps including closing the shutter and turning off the at least one effusion cell to terminate the evaporation of alkali-metal (5A), closing the shutter and turning off the at least one thermal cracker cell to terminate the evaporation of elemental sulfur (5B), backfilling the processing chamber with inter gas to bring to atmospheric pressure (5C), and opening the chamber door to remove the collection crucible (5D). Note that the at least one effusion cell and thermal cracker cells may be cooled with chilled water or antifreeze.

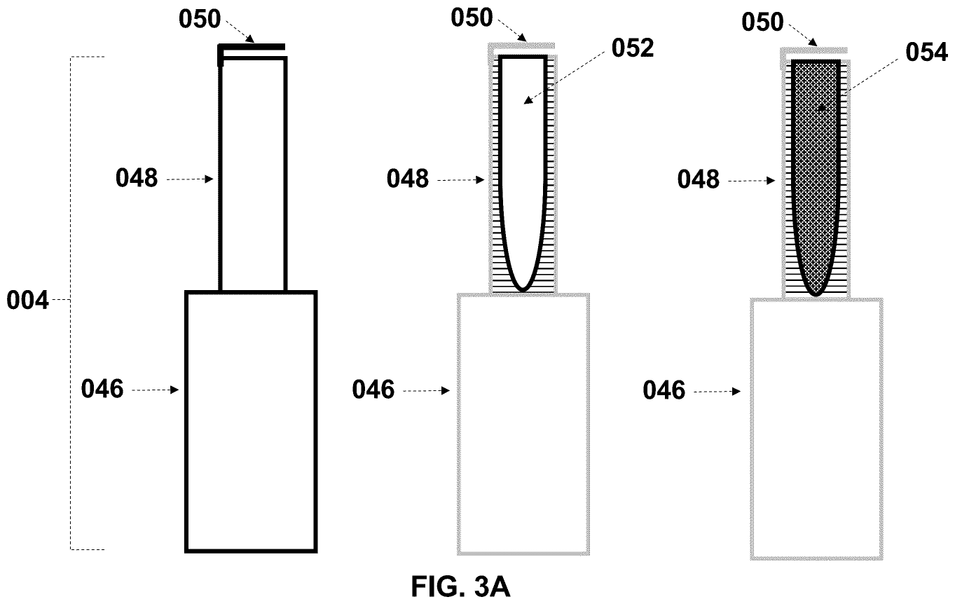

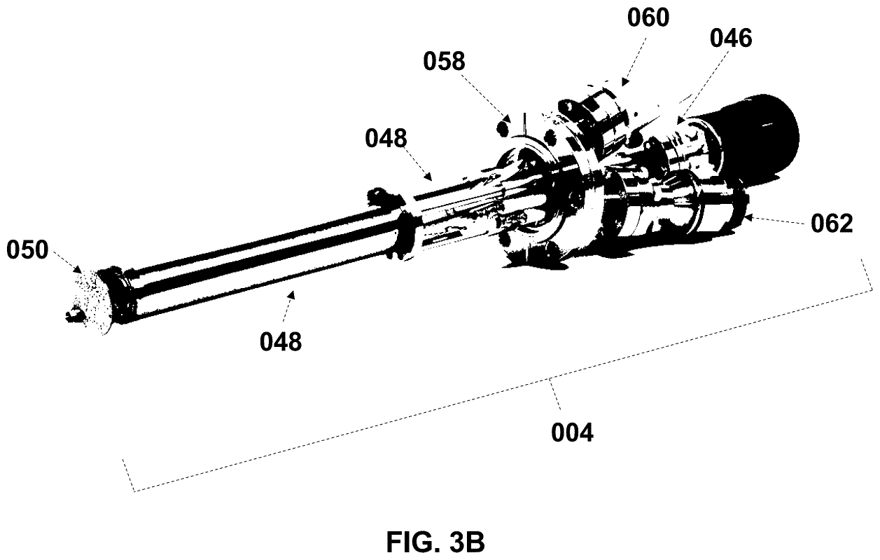

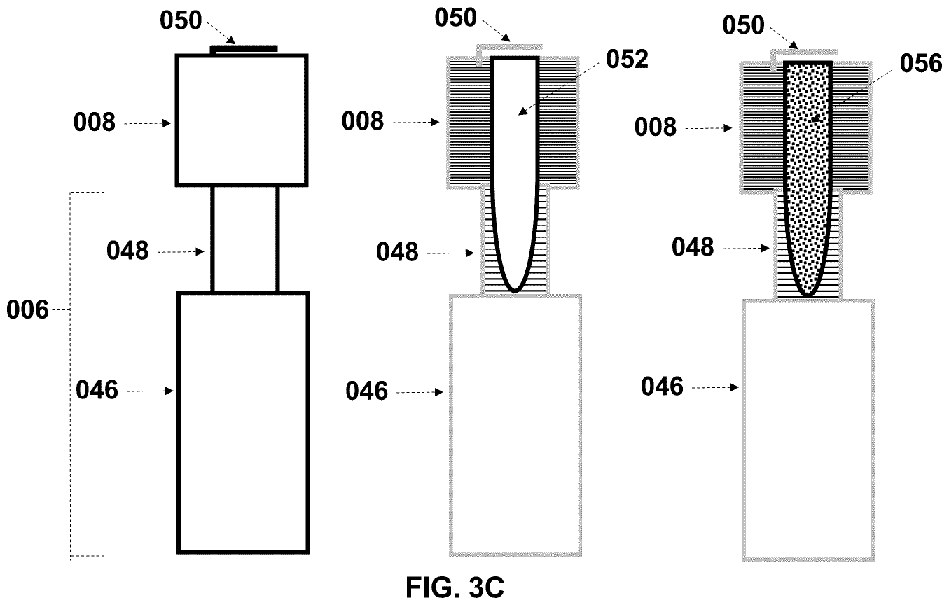

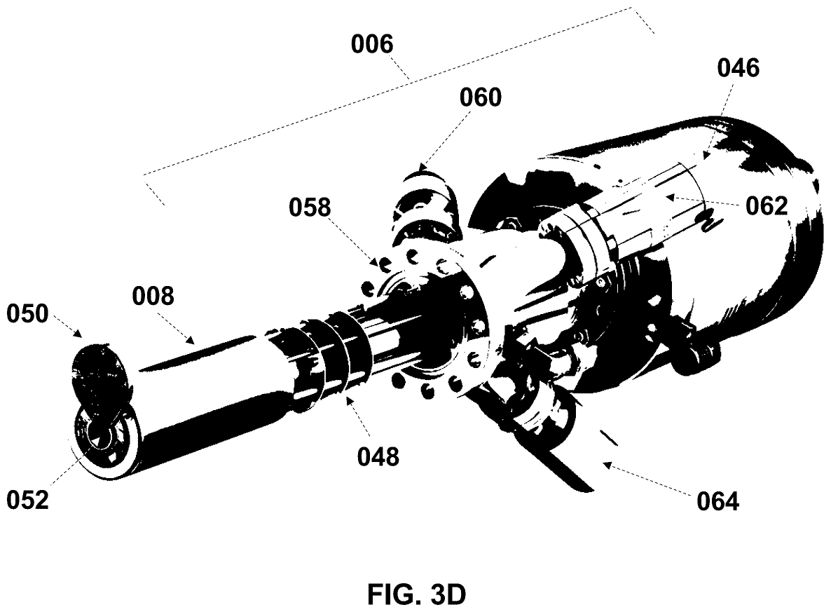

FIG. 3A: A schematic illustration of an effusion cell (004) comprising a reservoir/heat sink (046), a tube (048), a shutter (050), a crucible (052), and alkali-metal (054) packed into the crucible. The tube (048) may further comprise (not shown) one or more heat filaments, chilled cooling lines, a thermocouple, etc.

FIG. 3B: A digital image of an effusion cell (004) comprising a reservoir/heat sink (046), a tube (048), a shutter (050), a mounting flange (058), a filament port (060), and a thermocouple port (062). The tube (048) may further comprise (not shown) one or more heat filaments, chilled cooling lines, a thermocouple, etc.

FIG. 3C: A schematic illustration of a thermal cracker cell (006) comprising a cracker head (008), a reservoir/heat sink (046), a tube (048), a shutter (050), a crucible (052), and elemental sulfur (056) packed into the crucible. The tube (048) may further comprise (not shown) one or more heat filaments, chilled cooling lines, a thermocouple, etc.

FIG. 3D: A digital image of a thermal cracker cell (006) comprising a cracker head (008), a reservoir/heat sink (046), a tube (048), a shutter (050), a crucible (052), a mounting flange (058), a filament port (060), a thermocouple port (062), and chilled water port (064). The tube (048) may further comprise (not shown) one or more heat filaments, chilled cooling lines, a thermocouple, etc.

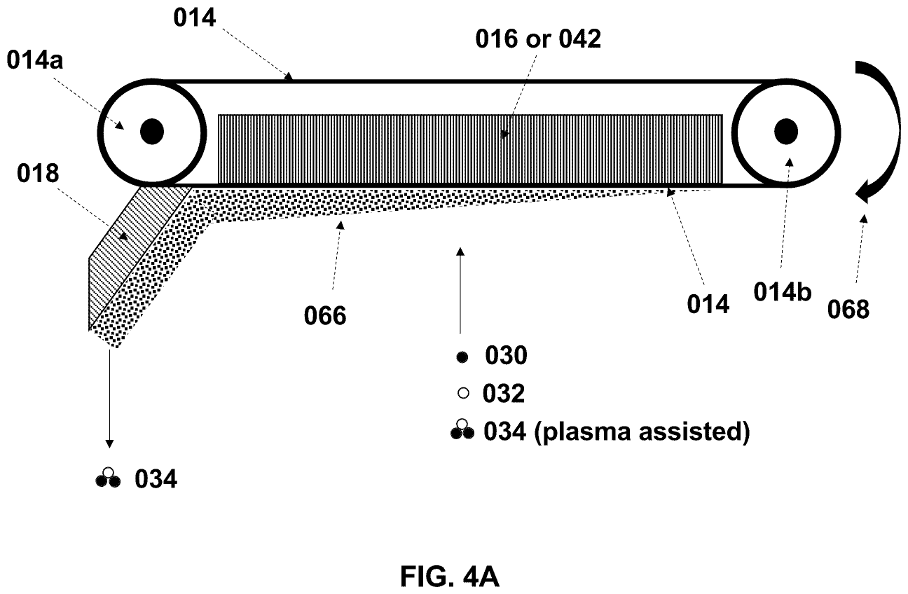

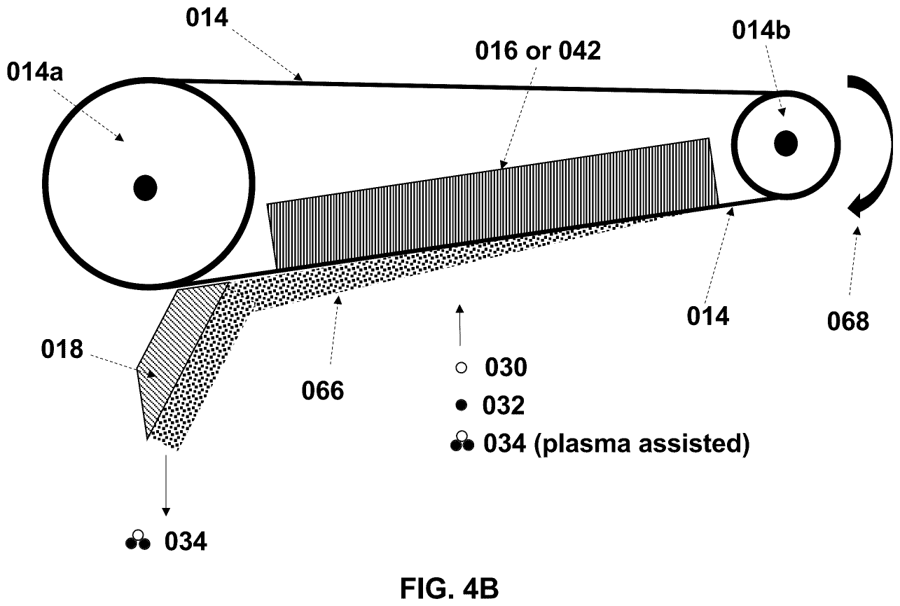

FIG. 4A: A schematic illustration of a rotating conveyor belt system, the system comprising a single rotating conveyor belt (014), a heat block (016) or cold block (042) depending on the processing approach, and a knife or blade (018). The system further comprises two pulley wheels (014a and 014b) of similar size and is rotating in the clockwise direction (068). A material layer (066) deposited on the surface of the single rotating conveyor belt (014) comprises alkali metal sulfide (030) and elemental sulfur (032), in the case of a heat-assisted approach, and alkali-metal sulfide (034) in the case of plasma-assisted processing (as well as the possibility of residual alkali metal and elemental sulfur). The knife or blade (018) removes the material layer (066) deposited on the surface of the single rotating conveyor belt (014), comprising entirely of alkali-metal sulfide (034), which deposits into the at least one collection crucible at the bottom of the processing chamber (not shown).

FIG. 4B: A schematic illustration of a rotating conveyor belt system, the system comprising a single rotating conveyor belt (014), a heat block (016) or cold block (042) depending on the processing approach, and a knife or blade (018). The system further comprises two pulley wheels (014a and 014b) of different sizes and is rotating in the clockwise direction (068). A material layer (066) deposited on the surface of the single rotating conveyor belt (014) comprises alkali metal sulfide (030) and elemental sulfur (032), in the case of a heat-assisted approach, and alkali-metal sulfide (034) in the case of plasma-assisted processing (as well as the possibility of residual alkali metal and elemental sulfur). The knife or blade (018) removes the material layer (066) deposited on the surface of the single rotating conveyor belt (014), comprising entirely of alkali-metal sulfide (034), which deposits into the at least one collection crucible at the bottom of the processing chamber (not shown).

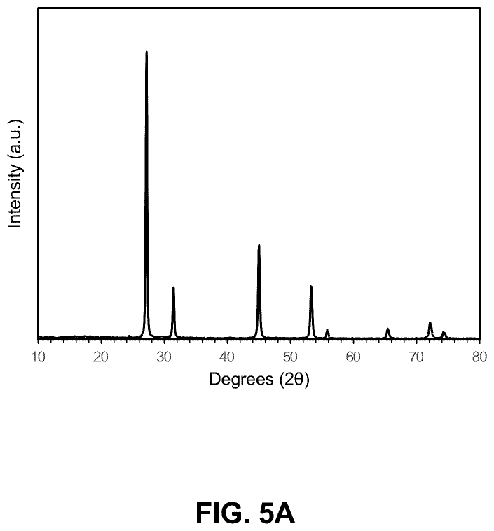

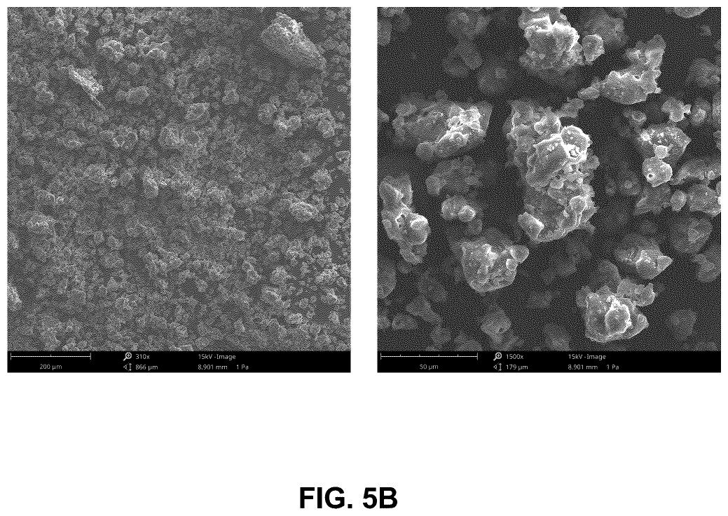

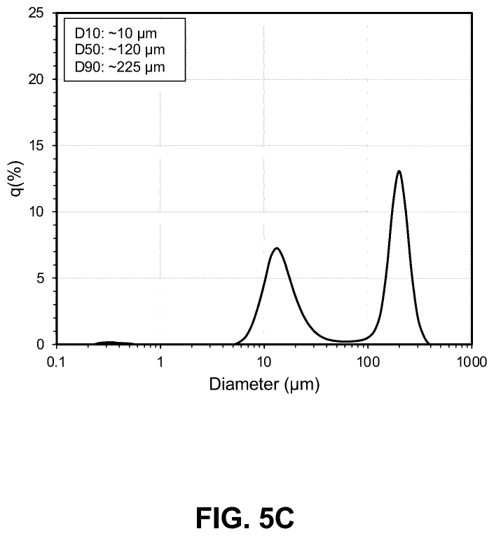

FIG. 5A: A representative x-ray diffraction pattern of an alkali-metal sulfide produced using a heat-assisted processing approach.

FIG. 5B: A representative scanning electron microscopy image of an alkali-metal sulfide produced using a heat-assisted processing approach.

FIG. 5C: A representative particle size distribution plot of an alkali-metal sulfide produced using a heat-assisted processing approach with D10, D50, and D90 values of 10, 120, and 250 μm, respectively.

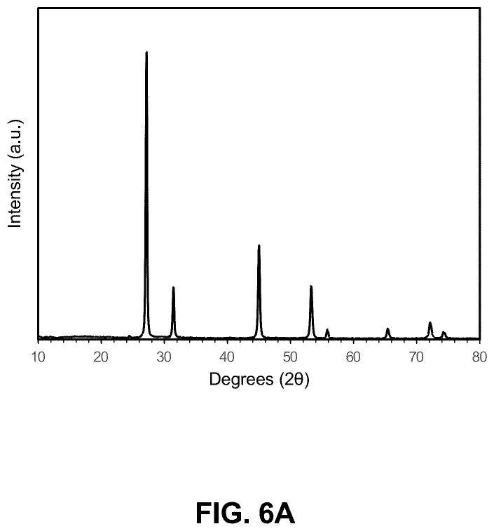

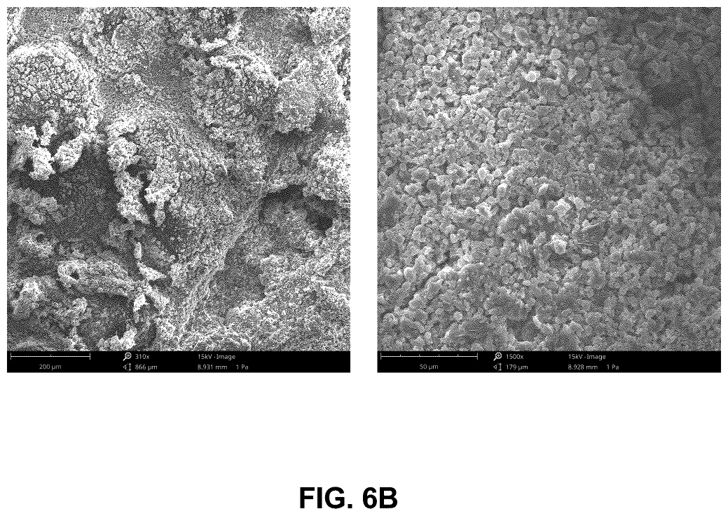

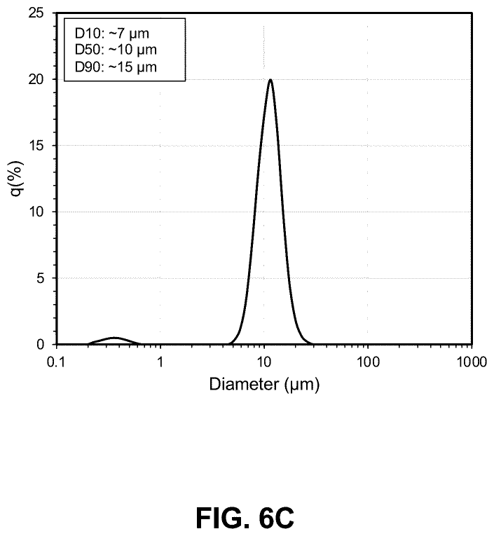

FIG. 6A: A representative x-ray diffraction pattern of an alkali-metal sulfide produced using a plasma-assisted processing approach.

FIG. 6B: A representative scanning electron microscopy image of an alkali-metal sulfide produced using a plasma-assisted processing approach, demonstrating a clear difference in particle size compared to the scanning electron microscopy image of the alkali-metal sulfide material produced using a heat-assisted approach in FIG. 5B.

FIG. 6C: A representative particle size distribution plot of an alkali-metal sulfide produced using a plasma-assisted processing approach with D10, D50, and D90 values of 7, 10, and 15 μm, respectively.

The above-described method can be ascribed to lithium sulfide powder (Li₂S) for secondary batteries, particularly lithium batteries. For example, Li₂S can be used as an electrode for lithium-sulfur batteries.

The above-described method can be ascribed to lithium sulfide powder (Li₂S) as a precursor in sulfide-based solid-state electrolyte production for solid-state lithium batteries.

The above-described method can be ascribed to lithium sulfide powder (Li₂S) as a precursor for the production of sulfide-based solid-state electrolytes with the general formula Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

The above-described method can be ascribed to lithium sulfide powder (Li₂S) as a precursor for the production of sulfide-based solid-state electrolytes with the general formula: Li₁₂₋ₘ₋ₓ(MₘY₄²⁻)Y₂₋ₓ²⁻Xₓ⁻; wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X=F⁻, Cl⁻, Br⁻, I⁻, or a combination thereof; and x is in the range of 0≤x≤2.

The above-described method can be ascribed to lithium sulfide powder (Li₂S) as a precursor for the production of sulfide-based solid-state electrolytes with the general formula: Li₁₈₋₂ₘ₋ₓ(M₂^{m+}Y₇²⁻)Y₂₋ₓ²⁻Xₓ⁻; wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X=F⁻, Cl⁻, Br⁻, I⁻, or a combination thereof; and x is in the range of 0≤x≤2.

The above-described method can be ascribed to sodium sulfide powder (Na₂S) for secondary batteries, particularly sodium batteries. For example, Na₂S can be used as an electrode for sodium-sulfur batteries.

The above-described method can be ascribed to sodium sulfide powder (Na₂S) as a precursor in sulfide-based solid-state electrolyte production for solid-state sodium batteries.

The above-described method can be ascribed to sodium sulfide powder (Na₂S) as a precursor for the production of sulfide-based solid-state electrolytes with the general formula Na₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

The above-described method can be ascribed to sodium sulfide powder (Na₂S) as a precursor for the production of sulfide-based solid-state electrolytes with the general formula: Na₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X=F⁻, Cl⁻, Br⁻, I⁻, or a combination thereof; and x is in the range of 0≤x≤2.

The above-described method can be ascribed to sodium sulfide powder (Na₂S) as a precursor for the production of sulfide-based solid-state electrolytes with the general formula: Na₁₈₋₂ₘ₋ₓ(M₂^{m+}Y₇²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X=F⁻, Cl⁻, Br⁻, I⁻, or a combination thereof; and x is in the range of 0≤x≤2.

The above-described method can be ascribed to potassium sulfide powder (K₂S) for secondary batteries, particularly potassium batteries. For example, K₂S can be used as an electrode for potassium-sulfur batteries.

The above-described method can be ascribed to potassium sulfide powder (K₂S) as a precursor in sulfide-based solid-state electrolyte production for solid-state potassium batteries.

The above-described method can be ascribed to potassium sulfide powder (K₂S) as a precursor for the production of sulfide-based solid-state electrolytes with the general formula K₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

The above-described method can be ascribed to potassium sulfide powder (K₂S) as a precursor for the production of sulfide-based solid-state electrolytes with the general formula: K₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X=F⁻, Cl⁻, Br⁻, I⁻, or a combination thereof; and x is in the range of 0≤x≤2.

The above-described method can be ascribed to potassium sulfide powder (K₂S) as a precursor for the production of sulfide-based solid-state electrolytes with the general formula: K₁₈₋₂ₘ₋ₓ(M₂^{m+}Y₇²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X=F⁻, Cl⁻, Br⁻, I⁻, or a combination thereof; and x is in the range of 0≤x≤2.

In the drawings, the following reference numbers are noted:
002 Vacuum-compatible processing chamber
004 Effusion cell
006 Thermal cracker cell
008 Cracker head
010 Inert gas inlet
012 Vacuum inlet
014 Rotating conveyor belt
014a Pulley (closes to knife/blade)
014b Pulley
016 Heat block
018 Knife/blade
020 Collection crucible
022 Gearbox
024 Chamber door
026 Door hinge
028 Door latch
030 Alkali-metal
032 Elemental sulfur
034 Alkali-metal sulfide (M₂S)
036 Anode
038 Cathode
040 Voltage source
042 Cold block
044 Plasma plume
046 Reservoir/heat sink
048 Tube
050 Shutter
052 Crucible
054 Alkali-metal (inside the crucible)
056 Elemental sulfur (inside the crucible)
058 Mounting flange
060 Filament port
062 Thermocouple port
064 Chilled water port
066 Deposited material layer
068 Rotation in a clockwise direction

Although various embodiments of the disclosed system have been shown and described, modifications may occur to those skilled in the art upon reading the specification. The present application includes such modifications and is limited only by the scope of the claims.

1. A method for manufacturing alkali-metal sulfide with the chemical formula M₂S where M is at least one alkali metal, the method comprising:
generating a vapor of an alkali metal;
generating a vapor of elemental sulfur;
bringing the generated alkali metal vapor into contact with the generated elemental sulfur vapor; and
initiating a reaction between the alkali metal vapor and the elemental sulfur vapor to produce the alkali-metal sulfide.

2. The method of claim 1, further comprising conducting the reaction in a vacuum-compatible processing chamber equipped with at least one effusion cell for generating the alkali metal and at least one thermal cracker cell for generating elemental sulfur.

3. The method of claim 2, wherein the effusion cell is operated at a temperature in the range of 200° C. to 1500° C.

4. The method of claim 2, wherein the thermal cracker cell is operated at a temperature in the range of 100° C. to 900° C.

5. The method of claim 2, wherein the generated alkali metal vapor has a gaseous flux that is 1.5 to 2.5 times higher than the flux of the generated elemental sulfur vapor.

6. The method of claim 2, further comprising a substrate within the processing chamber for collecting the synthesized alkali-metal sulfide.

7. The method of claim 6, wherein the substrate is a rotating conveyor belt.

8. The method of claim 7, further including a temperature-control block positioned adjacent to the rotating conveyor belt to regulate the temperature during the reaction.

9. The method of claim 8, wherein the temperature-control block serves as a heat block with a temperature range of 0° C. to 2000° C.

10. The method of claim 8, wherein the temperature-control block functions as a cold block with a temperature range capable of quenching the reaction, from −270° C. to 500° C.

11. The method of claim 1, further comprising ionizing the generated alkali metal and elemental sulfur vapors in an electric field to initiate the reaction, wherein the electric field is generated by at least one plasma-generating system comprising at least one cathode and one anode connected to an external power source.

12. The method of claim 11, wherein a voltage applied across the cathode and anode creates an electric field strength in the range of 0 to 100,000 kilovolts per meter (kV/m).

13. The method of claim 1, wherein the produced alkali-metal sulfide is collected and removed from the reaction site using a collection mechanism.

14-15. (canceled)

16. The method of claim 7, wherein the rotating conveyor belt is controlled to maintain a predetermined rotation speed.

17. The method of claim 6, wherein the substrate's temperature is regulated by direct physical contact with a temperature-control block.

18. The method of claim 13, further comprising removing the alkali-metal sulfide from the substrate using a mechanical device.

19-23. (canceled)

24. An alkali-metal sulfide powder with the chemical formula M₂S, where M is at least one alkali metal, characterized by:
a median particle size (D50) of 0.01 μm to 10,000 μm;
a D10 value at least 5% of the D50 value; and
a D90 value no more than 300% of the D50 value.

25. The alkali-metal sulfide powder of claim 24, having a morphology wherein over 50 wt % of the particles exhibit a sphericity index greater than 0.7.

26. The alkali-metal sulfide powder of claim 24, having a purity of at least 99.5% by weight.

27. A method for manufacturing alkali-metal chalcogenide with the chemical formula M₂X where M is at least one alkali metal and X is at least one chalcogenide, the method comprising:
generating a vapor of an alkali metal;
generating a vapor of a chalcogenide;
bringing the generated alkali metal vapor into contact with the generated chalcogenide vapor; and
initiating a reaction between the alkali metal vapor and the chalcogenide vapor to produce the alkali-metal chalcogenide.
